(19) United States
(12) Patent Application Publication
(10) Pub. No.: US 2026/0093321 A1
(43) Pub. Date: Apr. 2, 2026

(54) SYSTEMS AND METHODS FOR DYNAMIC INPUT BEHAVIORS

(71) Applicant: Apple Inc., Cupertino, CA (US)

(72) Inventors: Jessica TRINH, Oakland, CA (US); Alexandria G. HESTON, San Francisco, CA (US); Anna L. BREWER, San Francisco, CA (US); David Grayson SMITH, San Francisco, CA (US); Thomas J. MOORE, Northglenn, CO (US)

(21) Appl. No.: 19/326,464

(22) Filed: Sep. 11, 2025

Related U.S. Application Data
(60) Provisional application No. 63/700,172, filed on Sep. 27, 2024.

(51) Int. Cl. G06F 3/01

(52) U.S. Cl. CPC G06F 3/013

(57) ABSTRACT

Some examples of the disclosure are directed to systems and methods for dynamic input behaviors. In some examples, an electronic device can automatically adjust an input detected at an intelligent input device to accomplish user intent even when the input is already assigned to another action. In some examples, a scroll input can be dampened based on direction of gaze.

For example, the electronic device can reduce the scroll speed of an interface element based on detecting that the gaze of the user is searching for a specific item. In some examples, a scroll input can perform different actions based on a speed of the scroll input. In some examples, the electronic device can display context-driven indications of actions that can be performed when gaze is detected at the indications. The indications and their corresponding operations can change based on context.

### CROSS-REFERENCE TO RELATED APPLICATIONS

This application claims the benefit of U.S. Provisional Application No. 63/700,172, filed Sep. 27, 2024, the entire disclosure of which is herein incorporated by reference for all purposes.

### FIELD OF THE DISCLOSURE

This relates generally to systems and methods of operating an electronic device, and more particularly, to context-driven input behaviors at an electronic device.

### BACKGROUND OF THE DISCLOSURE

Some computer graphical environments provide two-dimensional and/or three-dimensional environments where at least some objects displayed for a user's viewing are virtual and generated by a computer. In some examples, a head-mounted device is adapted to perform operations based on context-driven user inputs.

### SUMMARY OF THE DISCLOSURE

Some examples of the disclosure are directed to systems and methods for dynamic input behaviors. In some examples, the system of the present disclosure can include an electronic device (e.g., a head-mounted device) having an intelligent input device. In some examples, an input detected at the intelligent input device can perform different actions based on the determined intent of the input. For example, the electronic device can automatically adjust an input (e.g., a gesture) detected at the intelligent input device to accomplish user intent even when the input is already assigned to another action. In some examples, a scroll input (e.g., a swipe gesture) can be dampened based on direction of gaze. For example, the electronic device can reduce the scroll speed of an interface element based on detecting that the gaze of the user is searching for a specific item. In some examples, a scroll input can perform different actions based on a speed of the scroll input. For example, a scroll input that scrolls an interface element at a slower speed can cease display of the interface element when performed at a greater speed. In some examples, the electronic device can display context-driven indications of actions that can be performed when gaze is detected at the indications. The indications and their corresponding operations can change based on context.

The full descriptions of these examples are provided in the Drawings and the Detailed Description, and it is understood that this Summary does not limit the scope of the disclosure in any way.

### BRIEF DESCRIPTION OF THE DRAWINGS

For improved understanding of the various examples described herein, reference should be made to the Detailed Description below along with the following drawings. Like reference numerals often refer to corresponding parts throughout the drawings.

FIG. 1 illustrates an electronic device presenting an extended reality environment according to some examples of the disclosure.

FIGS. 2A-2B illustrate block diagrams of example architectures for electronic devices according to some examples of the disclosure.

FIGS. 3A-3C illustrate an example electronic device having an intelligent input device according to examples of the disclosure.

FIGS. 4A-4B illustrate an example of an electronic device featuring attention-based scroll stabilization according to examples of the disclosure.

FIGS. 5A-5C illustrate an example of an electronic device featuring velocity based-swipe detection according to examples of the disclosure.

FIGS. 6A-6D illustrate an example of an electronic device including context-driven active display regions according to examples of the disclosure.

FIGS. 7A-7D illustrate an example of an electronic device including context-driven active display regions according to examples of the disclosure.

FIGS. 8A-8D illustrate an example of an electronic device including context-driven active display regions according to examples of the disclosure.

FIGS. 9A-9D illustrate an example of an electronic device including context-driven active display regions according to examples of the disclosure.

FIGS. 10A-10D illustrate an example of an electronic device including context-driven active display regions according to examples of the disclosure.

FIG. 11 illustrates an example flowchart of a method 1100 according to an example of the disclosure.

FIG. 12 illustrates an example flowchart of a method 1200 according to an example of the disclosure.

FIG. 13 illustrates an example flowchart of a method 1300 according to an example of the disclosure.

FIG. 14 illustrates an example flowchart of a method 1400 according to an example of the disclosure.

### DETAILED DESCRIPTION

Some examples of the disclosure are directed to systems and methods for dynamic input behaviors. In some examples, the system of the present disclosure can include an electronic device (e.g., a head-mounted device) having an intelligent input device. In some examples, an input detected at the intelligent input device can perform different actions based on the determined intent of the input. For example, the electronic device can automatically adjust an input (e.g., a gesture) detected at the intelligent input device to accomplish user intent even when the input is already assigned to another action. In some examples, a scroll input (e.g., a swipe gesture) can be dampened based on direction of gaze. For example, the electronic device can reduce the scroll speed of an interface element based on detecting that the gaze of the user is searching for a specific item. In some examples, a scroll input can perform different actions based on a speed of the scroll input. For example, a scroll input that scrolls an interface element at a slower speed can cease display of the interface element when performed at a greater speed. In some examples, the electronic device can display context-driven indications of actions that can be performed when gaze is detected at the indications. The indications and their corresponding operations can change based on context.

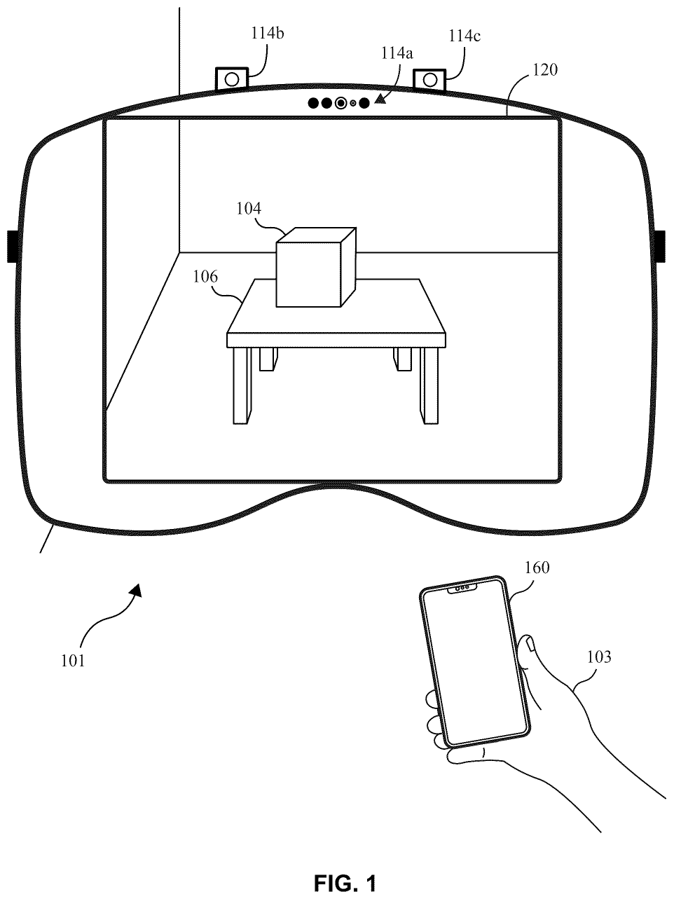

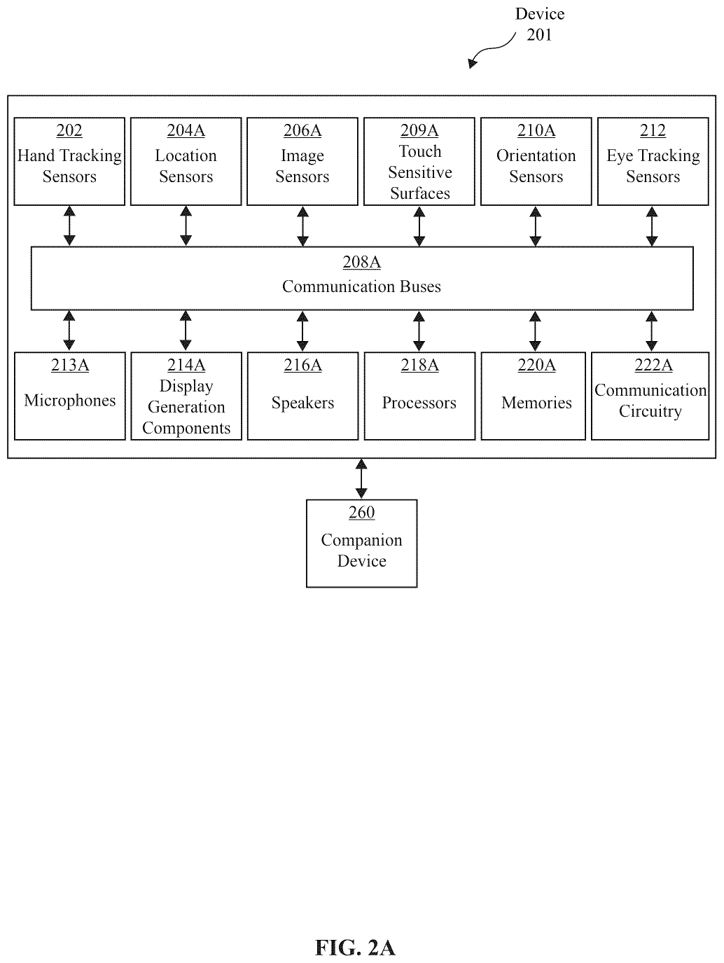

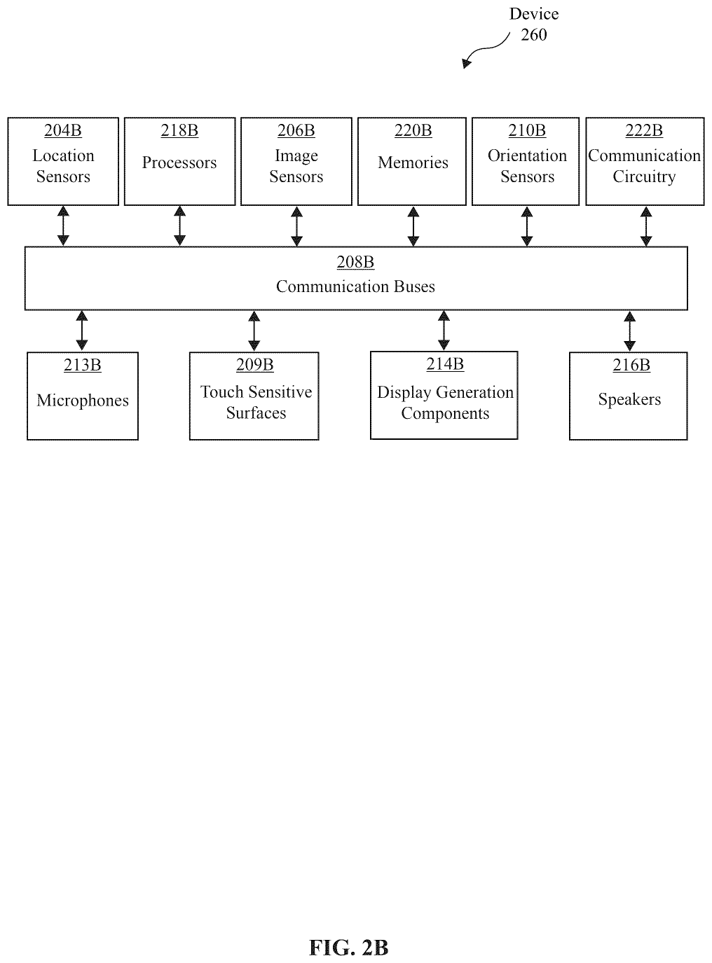

FIG. 1 illustrates an electronic device 101 presenting three-dimensional environment (e.g., an extended reality (XR) environment or a computer-generated reality (CGR) environment, optionally including representations of physical and/or virtual objects), according to some examples of the disclosure. In some examples, as shown in FIG. 1, electronic device 101 is a head-mounted display or other head-mountable device configured to be worn on a head of a user of the electronic device 101. Examples of electronic device 101 are described below with reference to the architecture block diagram of FIG. 2A. As shown in FIG. 1, electronic device 101 and table 106 are located in a physical environment. The physical environment may include physical features such as a physical surface (e.g., floor, walls) or a physical object (e.g., table, lamp, etc.). In some examples, electronic device 101 may be configured to detect and/or capture images of the physical environment including table 106 (illustrated in the field of view of electronic device 101).

In some examples, as shown in FIG. 1, electronic device 101 includes one or more internal image sensors 114a oriented towards a face of the user (e.g., eye tracking cameras as described below with reference to FIGS. 2A-2B). In some examples, internal image sensors 114a are used for eye tracking (e.g., detecting a gaze of the user). Internal image sensors 114a are optionally arranged on the left and right portions of display 120 to enable eye tracking of the user's left and right eyes. In some examples, electronic device 101 also includes external image sensors 114b and 114c facing outwards from the user to detect and/or capture the physical environment of the electronic device 101 and/or movements of the user's hands or other body parts.

In some examples, display 120 has a field of view visible to the user. In some examples, the field of view visible to the user is the same as a field of view of external image sensors 114b and 114c. For example, when display 120 is optionally part of a head-mounted device, the field of view of display 120 is optionally the same as or similar to the field of view of the user's eyes. In some examples, the field of view visible to the user is different from a field of view of external image sensors 114b and 114c (e.g., narrower than the field of view of external image sensors 114b and 114c). In other examples, the field of view of display 120 may be smaller than the field of view of the user's eyes. A viewpoint of a user determines what content is visible in the field of view, a viewpoint generally specifies a location and a direction relative to the three-dimensional environment. As the viewpoint of a user shifts, the field of view of the three-dimensional environment will also shift accordingly. In some examples, electronic device 101 may be an optical see-through device in which display 120 is a transparent or translucent display through which portions of the physical environment may be directly viewed. In some examples, display 120 may be included within a transparent lens and may overlap all or a portion of the transparent lens. In other examples, electronic device may be a video-passthrough device in which display 120 is an opaque display configured to display images of the physical environment using images captured by external image sensors 114b and 114c. While a single display is shown in FIG. 1, it is understood that display 120 optionally includes more than one display. For example, display 120 optionally includes a stereo pair of displays (e.g., left and right display panels for the left and right eyes of the user, respectively) having displayed outputs that are merged (e.g., by the user's brain) to create the view of the content shown in FIG. 1. In some examples, as discussed in more detail below with reference to FIGS. 2A-2B, the display 120 includes or corresponds to a transparent or translucent surface (e.g., a lens) that is not equipped with display capability (e.g., and is therefore unable to generate and display the virtual object 104) and alternatively presents a direct view of the physical environment in the user's field of view (e.g., the field of view of the user's eyes).

In some examples, the electronic device 101 is configured to display (e.g., in response to a trigger) a virtual object 104 in the three-dimensional environment. Virtual object 104 is represented by a cube illustrated in FIG. 1, which is not present in the physical environment, but is displayed in the three-dimensional environment positioned on the top of table 106 (e.g., real-world table or a representation thereof). Optionally, virtual object 104 is displayed on the surface of the table 106 in the three-dimensional environment displayed via the display 120 of the electronic device 101 in response to detecting the planar surface of table 106 in the physical environment 100.

It is understood that virtual object 104 is a representative virtual object and one or more different virtual objects (e.g., of various dimensionality such as two-dimensional or other three-dimensional virtual objects) can be included and rendered in a three-dimensional environment. For example, the virtual object can represent an application or a user interface displayed in the three-dimensional environment. In some examples, the virtual object can represent content corresponding to the application and/or displayed via the user interface in the three-dimensional environment. In some examples, the virtual object 104 is optionally configured to be interactive and responsive to user input (e.g., air gestures, such as air pinch gestures, air tap gestures, and/or air touch gestures), such that a user may virtually touch, tap, move, rotate, or otherwise interact with, the virtual object 104.

As discussed herein, one or more air pinch gestures performed by a user (e.g., with hand 103 in FIG. 1) are detected by one or more input devices of electronic device 101 and interpreted as one or more user inputs directed to content displayed by electronic device 101.

Additionally or alternatively, in some examples, the one or more user inputs interpreted by the electronic device 101 as being directed to content displayed by electronic device 101 (e.g., the virtual object 104) are detected via one or more hardware input devices (e.g., controllers, touch pads, proximity sensors, buttons, sliders, knobs, etc.) rather than via the one or more input devices that are configured to detect air gestures, such as the one or more air pinch gestures, performed by the user. Such depiction is intended to be exemplary rather than limiting; the user optionally provides user inputs using different air gestures and/or using other forms of input.

In some examples, the electronic device 101 may be configured to communicate with a second electronic device, such as a companion device. For example, as illustrated in FIG. 1, the electronic device 101 is optionally in communication with electronic device 160. In some examples, electronic device 160 corresponds to a mobile electronic device, such as a smartphone, a tablet computer, a smart watch, a laptop computer, or other electronic device. In some examples, electronic device 160 corresponds to a non-mobile electronic device, which is generally stationary and not easily moved within the physical environment (e.g., desktop computer, server, etc.). Additional examples of electronic device 160 are described below with reference to the architecture block diagram of FIG. 2B. In some examples, the electronic device 101 and the electronic device 160 are associated with a same user. For example, in FIG. 1, the electronic device 101 may be positioned on (e.g., mounted to) a head of a user and the electronic device 160 may be positioned near electronic device 101, such as in a hand 103 of the user (e.g., the hand 103 is holding the electronic device 160), a pocket or bag of the user, or a surface near the user. The electronic device 101 and the electronic device 160 are optionally associated with a same user account of the user (e.g., the user is logged into the user account on the electronic device 101 and the electronic device 160). Additional details regarding the communication between the electronic device 101 and the electronic device 160 are provided below with reference to FIGS. 2A-2B.

In some examples, displaying an object in a three-dimensional environment is caused by or enables interaction with one or more user interface objects in the three-dimensional environment. For example, initiation of display of the object in the three-dimensional environment can include interaction with one or more virtual options/affordances displayed in the three-dimensional environment. In some examples, a user's gaze may be tracked by the electronic device as an input for identifying one or more virtual options/affordances targeted for selection when initiating display of an object in the three-dimensional environment. For example, gaze can be used to identify one or more virtual options/affordances targeted for selection using another selection input. In some examples, a virtual option/affordance may be selected using hand-tracking input detected via an input device in communication with the electronic device. In some examples, objects displayed in the three-dimensional environment may be moved and/or reoriented in the three-dimensional environment in accordance with movement input detected via the input device.

In the descriptions that follows, an electronic device that is in communication with one or more displays and one or more input devices is described. It is understood that the electronic device optionally is in communication with one or more other physical user-interface devices, such as a touch-sensitive surface, a physical keyboard, a mouse, a joystick, a hand tracking device, an eye tracking device, a stylus, etc. Further, as described above, it is understood that the described electronic device, display and touch-sensitive surface are optionally distributed between two or more devices. Therefore, as used in this disclosure, information displayed on the electronic device or by the electronic device is optionally used to describe information outputted by the electronic device for display on a separate display device (touch-sensitive or not). Similarly, as used in this disclosure, input received on the electronic device (e.g., touch input received on a touch-sensitive surface of the electronic device, or touch input received on the surface of a stylus) is optionally used to describe input received on a separate input device, from which the electronic device receives input information.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, a television channel browsing application, and/or a digital video player application.

FIGS. 2A-2B illustrate block diagrams of example architectures for electronic devices according to some examples of the disclosure. In some examples, electronic device 201 and/or electronic device 260 include one or more electronic devices. For example, the electronic device 201 may be a portable device, an auxiliary device in communication with another device, a head-mounted display, a head-worn speaker, etc., respectively. In some examples, electronic device 201 corresponds to electronic device 101 described above with reference to FIG. 1. In some examples, electronic device 260 corresponds to electronic device 160 described above with reference to FIG. 1.

As illustrated in FIG. 2A, the electronic device 201 optionally includes one or more sensors, such as one or more hand tracking sensors 202, one or more location sensors 204A, one or more image sensors 206A (optionally corresponding to internal image sensors 114a and/or external image sensors 114b and 114c in FIG. 1), one or more touch-sensitive surfaces 209A, one or more motion and/or orientation sensors 210A, one or more eye tracking sensors 212, one or more microphones 213A or other audio sensors, one or more body tracking sensors (e.g., torso and/or head tracking sensors), etc. The electronic device 201 optionally includes one or more output devices, such as one or more display generation components 214A, optionally corresponding to display 120 in FIG. 1, one or more speakers 216A, one or more haptic output devices (not shown), etc. The electronic device 201 optionally includes one or more processors 218A, one or more memories 220A, and/or communication circuitry 222A. One or more communication buses 208A are optionally used for communication between the above-mentioned components of electronic device 201.

Additionally, the electronic device 260 optionally includes the same or similar components as the electronic device 201. For example, as shown in FIG. 2B, the electronic device 260 optionally includes one or more location sensors 204B, one or more image sensors 206B, one or more touch-sensitive surfaces 209B, one or more orientation sensors 210B, one or more microphones 213B, one or more display generation components 214B, one or more speakers 216B, one or more processors 218B, one or more memories 220B, and/or communication circuitry 222B. One or more communication buses 208B are optionally used for communication between the above-mentioned components of electronic device 260.

The electronic devices 201 and 260 are optionally configured to communicate via a wired or wireless connection (e.g., via communication circuitry 222A, 222B) between the two electronic devices. For example, as indicated in FIG. 2A, the electronic device 260 may function as a companion device to the electronic device 201. For example, in some examples, the electronic device 260 processes sensor inputs from electronic devices 201 and 260 and/or generates content for display using display generation components 214A of electronic device 201.

Communication circuitry 222A, 222B optionally includes circuitry for communicating with electronic devices, networks, such as the Internet, intranets, a wired network and/or a wireless network, cellular networks, and wireless local area networks (LANs). Communication circuitry 222A, 222B optionally includes circuitry for communicating using near-field communication (NFC) and/or short-range communication, such as Bluetooth®, etc. In some examples, communication circuitry 222A, 222B includes or supports Wi-Fi (e.g., an 802.11 protocol), Ethernet, ultra-wideband (“UWB”), high frequency systems (e.g., 900 MHz, 2.4 GHz, and 5.6 GHz communication systems), or any other communications protocol, or any combination thereof.

One or more processors 218A, 218B include one or more general processors, one or more graphics processors, and/or one or more digital signal processors. In some examples, one or more processors 218A, 218B include one or more microprocessors, one or more central processing units, one or more application-specific integrated circuits, one or more field-programmable gate arrays, one or more programmable logic devices, or a combination of such devices. In some examples, memories 220A and/or 220B are a non-transitory computer-readable storage medium (e.g., flash memory, random access memory, or other volatile or non-volatile memory or storage) that stores computer-readable instructions configured to be executed by the one or more processors 218A, 218B to perform the techniques, processes, and/or methods described herein. In some examples, memories 220A and/or 220B can include more than one non-transitory computer-readable storage medium. A non-transitory computer-readable storage medium can be any medium (e.g., excluding a signal) that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on compact disc (CD), digital versatile disc (DVD), or Blu-ray technologies, as well as persistent solid-state memory such as flash, solid-state drives, and the like.

In some examples, one or more display generation components 214A, 214B include a single display (e.g., a liquid-crystal display (LCD), organic light-emitting diode (OLED), or other types of display). In some examples, the one or more display generation components 214A, 214B include multiple displays. In some examples, the one or more display generation components 214A, 214B can include a display with touch capability (e.g., a touch screen), a projector, a holographic projector, a retinal projector, a transparent or translucent display, etc. In some examples, the electronic device does not include one or more display generation components 214A or 214B. For example, instead of the one or more display generation components 214A or 214B, some electronic devices include transparent or translucent lenses or other surfaces that are not configured to display or present virtual content. However, it should be understood that, in such instances, the electronic device 201 and/or the electronic device 260 are optionally equipped with one or more of the other components illustrated in FIGS. 2A and 2B and described herein, such as the one or more hand tracking sensors 202, one or more eye tracking sensors 212, one or more image sensors 206A, and/or the one or more motion and/or orientations sensors 210A. Alternatively, in some examples, the one or more display generation components 214A or 214B are provided separately from the electronic devices 201 and/or 260. For example, the one or more display generation components 214A, 214B are in communication with the electronic device 201 (and/or electronic device 260), but are not integrated with the electronic device 201 and/or electronic device 260 (e.g., within a housing of the electronic devices 201, 260). In some examples, electronic devices 201 and 260 include one or more touch-sensitive surfaces 209A and 209B, respectively, for receiving user inputs, such as tap inputs and swipe inputs or other gestures (e.g., hand-based or finger-based gestures). In some examples, the one or more display generation components 214A, 214B and the one or more touch-sensitive surfaces 209A, 209B form one or more touch-sensitive displays (e.g., a touch screen integrated with each of electronic devices 201 and 260 or external to each of electronic devices 201 and 260 that is in communication with each of electronic devices 201 and 260).

Electronic devices 201 and 260 optionally include one or more image sensors 206A and 206B, respectively. The one or more image sensors 206A, 206B optionally include one or more visible light image sensors, such as charged coupled device (CCD) sensors, and/or complementary metal-oxide-semiconductor (CMOS) sensors operable to obtain images of physical objects from the real-world environment. The one or more image sensors 206A, 206B also optionally include one or more infrared (IR) sensors, such as a passive or an active IR sensor, for detecting infrared light from the real-world environment. For example, an active IR sensor includes an IR emitter for emitting infrared light into the real-world environment. The one or more image sensors 206A, 206B also optionally include one or more cameras configured to capture movement of physical objects in the real-world environment. The one or more image sensors 206A, 206B also optionally include one or more depth sensors configured to detect the distance of physical objects from electronic device 201, 260. In some examples, information from one or more depth sensors can allow the device to identify and differentiate objects in the real-world environment from other objects in the real-world environment. In some examples, one or more depth sensors can allow the device to determine the texture and/or topography of objects in the real-world environment. In some examples, the one or more image sensors 206A or 206B are included in an electronic device different from the electronic devices 201 and/or 260. For example, the one or more image sensors 206A, 206B are in communication with the electronic device 201, 260, but are not integrated with the electronic device 201, 260 (e.g., within a housing of the electronic device 201, 260). Particularly, in some examples, the one or more cameras of the one or more image sensors 206A, 206B are integrated with and/or coupled to one or more separate devices from the electronic devices 201 and/or 260 (e.g., but are in communication with the electronic devices 201 and/or 260), such as one or more input and/or output devices (e.g., one or more speakers and/or one or more microphones, such as earphones or headphones) that include the one or more image sensors 206A, 206B. In some examples, electronic device 201 or electronic device 260 corresponds to a head-worn speaker (e.g., headphones or earbuds). In such instances, the electronic device 201 or the electronic device 260 is equipped with a subset of the other components illustrated in FIGS. 2A and 2B and described herein. In some such examples, the electronic device 201 or the electronic device 260 is equipped with one or more image sensors 206A, 206B, the one or more motion and/or orientations sensors 210A, 210B, and/or speakers 216A, 216B.

In some examples, electronic device 201, 260 uses CCD sensors, event cameras, and depth sensors in combination to detect the physical environment around electronic device 201, 260. In some examples, the one or more image sensors 206A, 206B include a first image sensor and a second image sensor. The first image sensor and the second image sensor work in tandem and are optionally configured to capture different information of physical objects in the real-world environment. In some examples, the first image sensor is a visible light image sensor, and the second image sensor is a depth sensor. In some examples, electronic device 201, 260 uses the one or more image sensors 206A, 206B to detect the position and orientation of electronic device 201, 260 and/or the one or more display generation components 214A, 214B in the real-world environment. For example, electronic device 201, 260 uses the one or more image sensors 206A, 206B to track the position and orientation of the one or more display generation components 214A, 214B relative to one or more fixed objects in the real-world environment.

In some examples, electronic devices 201 and 260 include one or more microphones 213A and 213B, respectively, or other audio sensors. Electronic device 201, 260 optionally uses the one or more microphones 213A, 213B to detect sound from the user and/or the real-world environment of the user. In some examples, the one or more microphones 213A, 213B include an array of microphones (e.g., a plurality of microphones) that optionally operate in tandem, such as to identify ambient noise or to locate the source of sound in space of the real-world environment.

Electronic devices 201 and 260 include one or more location sensors 204A and 204B, respectively, for detecting a location of electronic device 201 and/or the one or more display generation components 214A and a location of electronic device 260 and/or the one or more display generation components 214B, respectively. For example, the one or more location sensors 204A, 204B can include a global positioning system (GPS) receiver that receives data from one or more satellites and allows electronic device 201, 260 to determine the absolute position of the electronic device in the physical world.

Electronic devices 201 and 260 include one or more orientation sensors 210A and 210B, respectively, for detecting orientation and/or movement of electronic device 201 and/or the one or more display generation components 214A and orientation and/or movement of electronic device 260 and/or the one or more display generation components 214B, respectively. For example, electronic device 201, 260 uses the one or more orientation sensors 210A, 210B to track changes in the position and/or orientation of electronic device 201, 260 and/or the one or more display generation components 214A, 214B, such as with respect to physical objects in the real-world environment. The one or more orientation sensors 210A, 210B optionally include one or more gyroscopes and/or one or more accelerometers.

Electronic device 201 includes one or more hand tracking sensors 202 and/or one or more eye tracking sensors 212, in some examples. It is understood, that although referred to as hand tracking or eye tracking sensors, that electronic device 201 additionally or alternatively optionally includes one or more other body tracking sensors, such as one or more leg, one or more torso and/or one or more head tracking sensors. The one or more hand tracking sensors 202 are configured to track the position and/or location of one or more portions of the user's hands, and/or motions of one or more portions of the user's hands with respect to the three-dimensional environment, relative to the one or more display generation components 214A, and/or relative to another defined coordinate system. The one or more eye tracking sensors 212 are configured to track the position and movement of a user's gaze (e.g., a user's attention, including eyes, face, or head, more generally) with respect to the real-world or three-dimensional environment and/or relative to the one or more display generation components 214A. In some examples, the one or more hand tracking sensors 202 and/or the one or more eye tracking sensors 212 are implemented together with the one or more display generation components 214A. In some examples, the one or more hand tracking sensors 202 and/or the one or more eye tracking sensors 212 are implemented separate from the one or more display generation components 214A. In some examples, electronic device 201 alternatively does not include the one or more hand tracking sensors 202 and/or the one or more eye tracking sensors 212. In some such examples, the one or more display generation components 214A may be utilized by the electronic device 260 to provide a three-dimensional environment and the electronic device 260 may utilize input and other data gathered via the other one or more sensors (e.g., the one or more location sensors 204A, the one or more image sensors 206A, the one or more touch-sensitive surfaces 209A, the one or more motion and/or orientation sensors 210A, and/or the one or more microphones 213A or other audio sensors) of the electronic device 201 as input and data that is processed by the one or more processors 218B of the electronic device 260. Additionally or alternatively, electronic device 260 optionally does not include other components shown in FIG. 2B, such as the one or more location sensors 204B, the one or more image sensors 206B, the one or more touch-sensitive surfaces 209B, etc. In some such examples, the one or more display generation components 214A may be utilized by the electronic device 260 to provide a three-dimensional environment and the electronic device 260 may utilize input and other data gathered via the one or more motion and/or orientation sensors 210A (and/or the one or more microphones 213A) of the electronic device 201 as input.

In some examples, the one or more hand tracking sensors 202 (and/or other body tracking sensors, such as leg, torso and/or head tracking sensors) can use the one or more image sensors 206 (e.g., one or more IR cameras, 3D cameras, depth cameras, etc.) that capture three-dimensional information from the real-world including one or more body parts (e.g., hands, legs, or torso of a human user). In some examples, the hands can be resolved with sufficient resolution to distinguish fingers and their respective positions. In some examples, the one or more image sensors 206A are positioned relative to the user to define a field of view of the one or more image sensors 206A and an interaction space in which finger/hand position, orientation and/or movement captured by the image sensors are used as inputs (e.g., to distinguish from a user's resting hand or other hands of other persons in the real-world environment). Tracking the fingers/hands for input (e.g., gestures, touch, tap, etc.) can be advantageous in that it does not require the user to touch, hold or wear any sort of beacon, sensor, or other marker.

In some examples, the one or more eye tracking sensors 212 include at least one eye tracking camera (e.g., IR cameras) and/or illumination sources (e.g., IR light sources, such as LEDs) that emit light towards a user's eyes. The eye tracking cameras may be pointed towards a user's eyes to receive reflected IR light from the light sources directly or indirectly from the eyes. In some examples, both eyes are tracked separately by respective eye tracking cameras and illumination sources, and a focus/gaze can be determined from tracking both eyes. In some examples, one eye (e.g., a dominant eye) is tracked by one or more respective eye tracking cameras/illumination sources.

Electronic devices 201 and 260 are not limited to the components and configuration of FIGS. 2A-2B, but can include fewer, other, or additional components in multiple configurations. In some examples, electronic device 201 and/or electronic device 260 can each be implemented between multiple electronic devices (e.g., as a system). In some such examples, each of (or more of) the electronic devices may include one or more of the same components discussed above, such as various sensors, one or more display generation components, one or more speakers, one or more processors, one or more memories, and/or communication circuitry. A person or persons using electronic device 201 and/or electronic device 260, is optionally referred to herein as a user or users of the device.

Attention is now directed towards context-driven interactions for an electronic device, including with one or more virtual objects that are displayed in a three-dimensional environment presented at an electronic device (e.g., corresponding to electronic device 201).

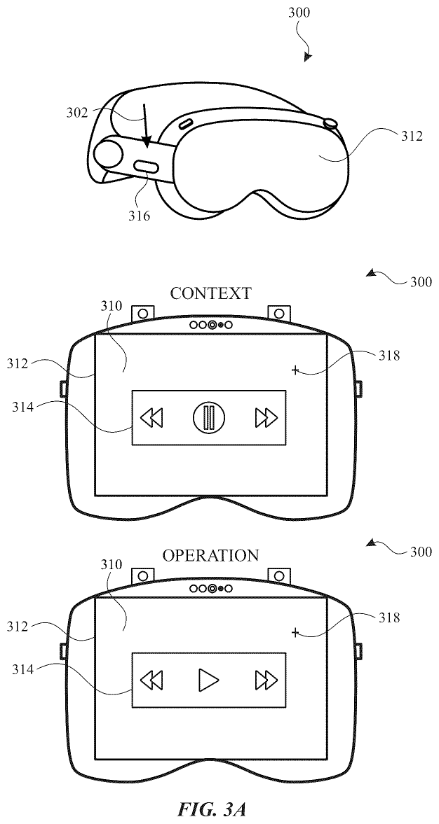

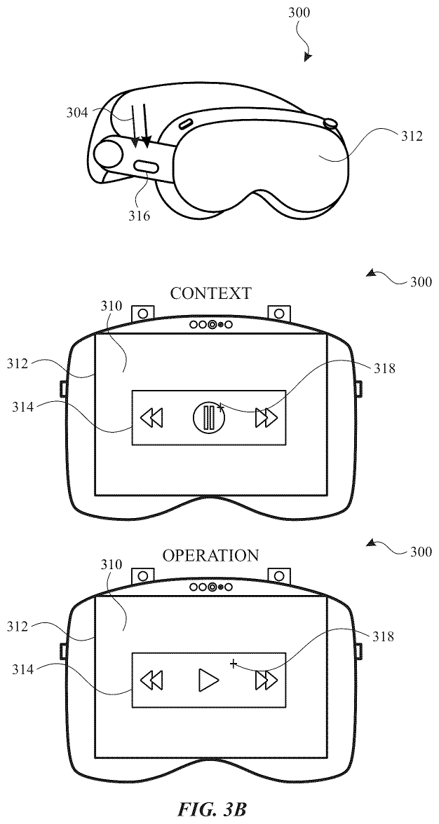

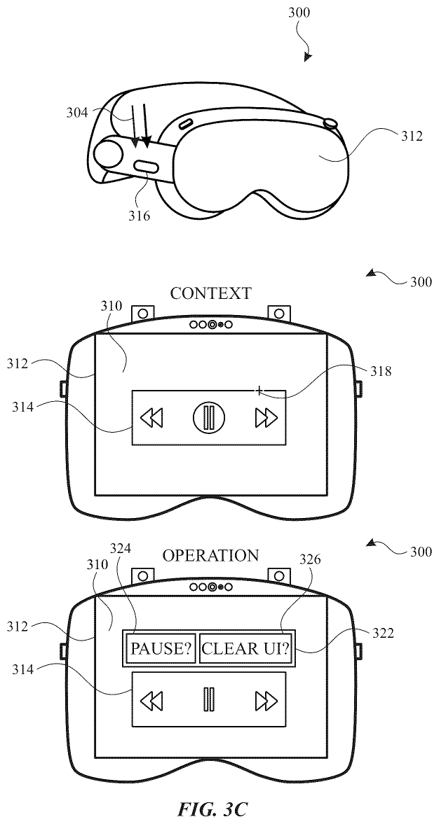

FIGS. 3A-3C illustrate an example electronic device 300 having an intelligent input device, according to examples of the disclosure. In some examples, the electronic device 300 is substantially similar to electronic devices 101 and 201, previously described. As such, the electronic device 300 can be in communication with one or more displays and one or more input devices. For example, the electronic device 300 can be a head-mounted device (e.g., a head-mounted display) worn by a user of the electronic device 300. In some examples, electronic device 300 includes a display generation component 312 (e.g., display generation component 214 described above in reference to electronic device 201). The one or more input devices can include physical user-interface devices, such as a touch-sensitive surface 316 (e.g., touch sensitive surface described above in reference to electronic device 201), a physical keyboard, a mouse, a joystick, a hand tracking device (e.g., hand tracking sensors 202 described above in reference to electronic device 201), an eye tracking device (e.g., eye tracking sensors 212 described above in reference to electronic device 201), a stylus, among other input devices. In some examples, the one or more input devices can include one or more sensors for detecting eye movement (e.g., eye tracking sensors 212 described above in reference to electronic device 201) which can be used to determine attention or gaze position and/or gaze movement which can optionally be used to detect gaze-only inputs based on gaze movement and/or dwell.

In some examples, such as illustrated in FIGS. 3A-3C, the one or more input devices can include touch-sensitive surface 316. Touch-sensitive surface 316 is configured to detect contact from a user (e.g., user's fingers and/or hands) and/or touch from a pointing device such as a stylus. Touch-sensitive surface 316 can detect user inputs such as tap inputs, swipe inputs, and other gestures. In some examples, touch-sensitive surface 316 is disposed on a surface of electronic device 300. In some examples, touch-sensitive surface is located on a different device that is in communication with the electronic device 300.

In some examples, for a given input device (such as touch-sensitive surface 316), the electronic device 300 can assign to an input type at the input device, an operation that can be performed in response to receiving the input type at the input device of electronic device 300.

Accordingly, in response to detecting an input of the input type at the input device, the electronic device 300 can perform the operation assigned to the input type. For example, for an input device such as touch-sensitive surface 316, the electronic device 300 can assign an operation to a tap input (e.g., an input in which the user of the electronic device brings a finger to the touch-sensitive surface 316 and then removes it), another operation to a double tap input, and a different operation to a swipe input. In some examples, the input assignments or equivalently, the mapping of input types to operations can be based on the application and specifically the interface of an application displayed by the electronic device. For instance, in the context of a music application that plays music, a tap input can be assigned to performing a pause/play operation, while a swipe input (wherein the user moves their finger across the touch-sensitive surface 316) can be assigned to raising and/or lower the volume (depending on the direction of the swipe input).

In some examples, even when an input type is assigned to a particular operation, the context in which the input type is being applied may not warrant the operation being performed. Thus, in one or more examples, the electronic device 300 can override the input assignments or mappings based on a current context of the electronic device 300. The electronic device 300 can thus automatically adjust certain inputs (e.g., gestures) detected at an input device (e.g., an intelligent input device) to accomplish user intent even when the detected inputs are already assigned to other operations.

FIG. 3A illustrates an example input-to-operation mapping according to examples of the disclosure. In the example of FIG. 3A, the electronic device 300 displays a first user interface in an environment 310. The first user interface is a media player interface 314. In FIG. 3A, a first operation is assigned or mapped to a first input type while the electronic device 300 displays the media player interface 314 (that is displayed as part of the electronic device executing a media application for playing media). For example, while the media player interface 314 is displayed and media playback is in progress, a “pause” operation can be assigned and/or mapped to a tap input (e.g., the first input type) detected at the touch-sensitive surface 316 (e.g., a first input device). Thus, while the media application is being executed, the electronic device assigns the pause operation to a detected tap at the touch-sensitive surface 316. In some examples, a second operation can be assigned to a second input type. For example, while the media player interface 314 is displayed and media playback is in progress, a “clear User Interface” (e.g., “clear UI”) operation can be assigned and/or mapped to a double tap input (e.g., the second input type) detected at the touch-sensitive surface 316 (e.g., a first input device).

As shown in FIG. 3A, while the electronic device 300 displays media player interface 314 (e.g., the first user interface), the electronic device 300 detects a tap input 302 (e.g., the first input type) at the touch-sensitive surface 316 (e.g., the first input device). The electronic device 300 can determine an intent of tap input 302 based on a current context. In some examples, a context can include an environment 310 presented at the display, such as an environment as described in reference to electronic device 101. In some examples, the context can include a location of the user within a three-dimensional environment and/or the virtual objects displayed in the three-dimensional environment displayed by the one or more displays 312. In some examples, the context can include an event or occurrence within the environment 310. In some examples, the context can include one or more applications the electronic device 300 presents at the one or more displays 312. In some examples, the context can include one or more user interfaces the electronic device 300 presents at the one or more displays 312. In some examples, the context can include the physical environment of the electronic device 300, as detected via the various sensors of the electronic device 300, such as described above in reference to electronic device 201 (e.g., one or more hand tracking sensors 202, one or more location sensors 204, one or more image sensors 206, one or more touch-sensitive surfaces 209, one or more motion and/or orientation sensors 210, one or more eye tracking sensors 212, one or more microphones 213 or other audio sensors, one or more body tracking sensors (e.g., torso and/or head tracking sensors)). For example, the context can include the electronic device 300 detecting via the one or more image sensors 206 that the user is indoors and not outside, or that the user is watching television or reading a book. For example, the context can include the electronic device detecting via the one more body tracking sensors that the user is standing up or sitting down.

In some examples, the electronic device 300 can detect an intent for the tap input 302 (e.g., the first input type) based on the current context that includes the media player interface 314 (e.g., the first user interface) and a direction of gaze 318 of the user. For example, when the electronic device 300 detects the tap input 302, playback is in progress and a gaze 318 of the user (e.g., as detection via one or more eye tracking sensors 212) is not directed to the media player interface 314. As previously described, a “pause” operation was assigned and/or mapped to the tap input (e.g., the first input type) on the touch-sensitive surface 316. The electronic device 300 determines based on the current context that the intent of the tap input is a request to perform the “pause” operation. Accordingly, in response to detecting the tap input 302, the electronic device can perform the “pause” operation (e.g., pause playback). The response of the electronic device 300 to the detection of the tap input 302 thus reflects the assignment of the “pause”operation to the tap input 302 at the touch-sensitive surface 316.

FIG. 3B illustrates an input-to-operation assignment override operation according to examples of the disclosure. In the example of FIG. 3B, while the electronic device 300 displays media player interface 314 (e.g., the first user interface), the electronic device 300 detects a double tap input 304 (e.g., the second input type) at the touch-sensitive surface 316 (e.g., the first input device). The electronic device 300 can determine an intent of the double tap input 304 based on the current context that includes the media player interface 314 (e.g., the first user interface) and a direction of gaze 318 of the user. For example, when the electronic device 300 detects the double tap input 304, playback is in progress at the media player interface 314. Further, unlike in FIG. 3A, where a gaze 318 of the user was directed at the environment 310, in FIG. 3B, the electronic device 300 detects that the gaze 318 of the user is directed to the media player interface 314. While as previously described, a “clear UI” operation was assigned and/or mapped to the double tap input 304 (e.g., the second input type) on the touch-sensitive surface 316, the electronic device 300 determines based on the current context (e.g., playback in progress and gaze 318 directed to the media player interface 314) that the intent of the double tap input 304 (e.g., the second input type) is a request to perform the “pause” operation (e.g., the first operation). Accordingly, in response to detecting the double tap input 304, the electronic device can perform the “pause” operation (e.g., pause playback). The electronic device 300 thus overrode the second operation assigned to the double tap input 304 (e.g., the “clear UI” operation based on the determination that the intent of the double tap input 304 (based on the current context of media player interface and direction of gaze 318) is a request to perform the first operation (a “pause” operation) instead. In one or more examples, the computer system determined from the context that the double tap input was received, that it was more likely that the user intended to perform a pause operation (and may have inadvertently double tapped when they meant to single tap), and thus overrode the operation assigned to a double tap to instead perform the operation that is normally assigned to a single tap (e.g., a pause operation).

In some examples, the intent based on current context has a confidence level, and determining the intent includes determining a confidence level associated with the intent. The confidence level of the intent based on current context can be affected by various factors that contribute to the determination of the current context, such as the first interface (e.g., media player interface 314) and the gaze 318 of the user. For example, as ambiguity in the direction of the gaze 318 of the user can affect (e.g., reduce) the confidence level in the intent, as will be further explained below. Therefore, in some examples, the electronic device 300 optionally performs the first operation at the electronic device 300 in accordance with a determination that the confidence level in the determined intent is above a confidence threshold.

FIG. 3C illustrates an example context, which when detected by the electronic device, causes the device to override the assigned operation according to one or more examples. In the example of FIG. 3C, electronic device 300 determines that the intent the first input having the second input type (e.g., the double tap input 304) is uncertain and/or ambiguous, and therefore not a clear request to perform the first operation (e.g., “pause” operation) or the second operation (e.g., “clear UI”) at the electronic device. As previously described, the electronic device 300 can determine an intent of the double tap input 304 based on the current context that includes the media player interface 314 (e.g., the first user interface) and a direction of gaze 318 of the user. For example, when the electronic device 300 detects the double tap input 304, playback is in progress at the media player interface 314. However, unlike in FIG. 3B, where a gaze 318 of the user was directed at the media player interface 314, in FIG. 3C, the location of the gaze 318 is uncertain, such that the electronic device 300 cannot determine with a sufficient degree of confidence the intent of the double tap input 304. For example, the gaze 318 of the user may not be fixated on the media player interface 314 for a sufficient duration to indicate an intent. In some examples, the gaze 318 of the user may be located at an edge of the media player interface 314 such that the electronic device 300 is unable to ascertain whether the user is looking at the media player interface 314 or the environment 310.

As shown in FIG. 3C therefore, in accordance with a determination that the intent for the double tap input 304 is not a request to perform the “pause” operation, the electronic device 300 can display a second user interface 322 including a first selectable option 324 (e.g., “pause?”) for performing the first operation (e.g., pause playback) and a second selectable option 326 (e.g., “clear UI?”) for performing the second operation (e.g., clear UI), different than the first operation. In some examples, second selectable option 326 corresponds to the assigned operation for a double tap, while first selectable option 324 corresponds to a possible override operation based on an intent with low confidence levels. In some examples, the electronic device 300 displays the second user interface 322 in accordance with a determination that a confidence level associated with the intent does not exceed (e.g., is not above) a confidence threshold. The second user interface 322 provides the user an opportunity to clarify the intent of an ambiguous input detected by the electronic device 300 at the touch-sensitive surface 316. Thus, the electronic device 300 can detect a second input directed to the first selection option 324 (e.g., “pause?”) or the second selectable option 326 (e.g., “clear UI?”) and in response, in accordance with a determination that the second input is directed to the first selectable option 324 (e.g., “pause?”), the electronic device 300 can perform the first operation at the electronic device (e.g., pause playback), and in accordance with a determination that the second input is directed to the second selectable option 326 (e.g., “clear UI?”), the electronic device can perform the second operation at the electronic device (e.g., clear UI). In one or more examples, the selectable options 324 and 326 can be accompanied by an audio notification (e.g., a sound is played) indicating that the electronic device 300 has low confidence as to what operation should be performed in response to a particular input based on the context that the input was performed in.

In some examples, in accordance with the determination that the confidence level associated with the intent does not exceed (e.g., is not above) a confidence threshold, the electronic device 300 optionally forgoes displaying the second user interface 322 and instead, performs the second operation (e.g., the operation assigned to the second input type). For example, in accordance with the determination that the confidence level associated with the determined intent of the double tap input 304 (e.g., a request to perform a “pause” operation at the electronic device 300) does not exceed (e.g., is not above) a confidence threshold, the electronic device 300 optionally performs the “clear UI” operation, which is the operation assigned or mapped to the double tap input 304. The electronic device 300 thus optionally forgoes overring input assignment or mapping for an input type and display of a second user interface 322 for clarifying the intent of the input and instead, performs the operation assigned to the input type of the input when the confidence level in the intent is below the confidence threshold.

Automatically adjusting an input detected at an intelligent input device to accomplish user intent even when the input is already assigned to another action as described above reduces ambiguity and misinterpretation of user inputs, and therefore minimizes erroneous inputs, which improves the reliability and efficiency of the user's interaction with the electronic device and preserves computing resources that would otherwise be used to correct an erroneous input by the user.

In one or more examples, inputs such as a swipe gesture can be used to perform a scroll operation on the electronic device 300. In one or more examples and as described in further detail below, the electronic device 300 can detect whether the user is looking for something specific while navigating through a user interface while scrolling (as opposed to causing scrolling and navigating without a specific intent) based on the movement of the user's eyes. In some examples, and as described in further detail below, the system can dampen scrolling speeds to allow the user to more easily search while the user interface is scrolling based on movement of the user's eyes.

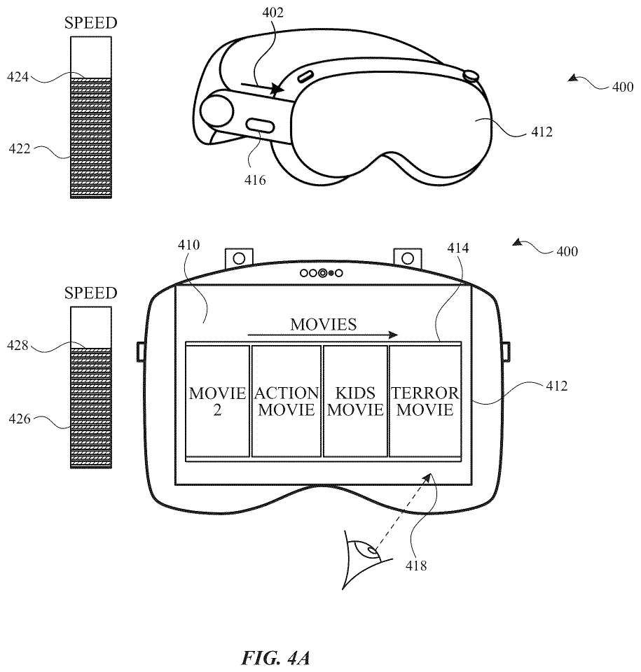

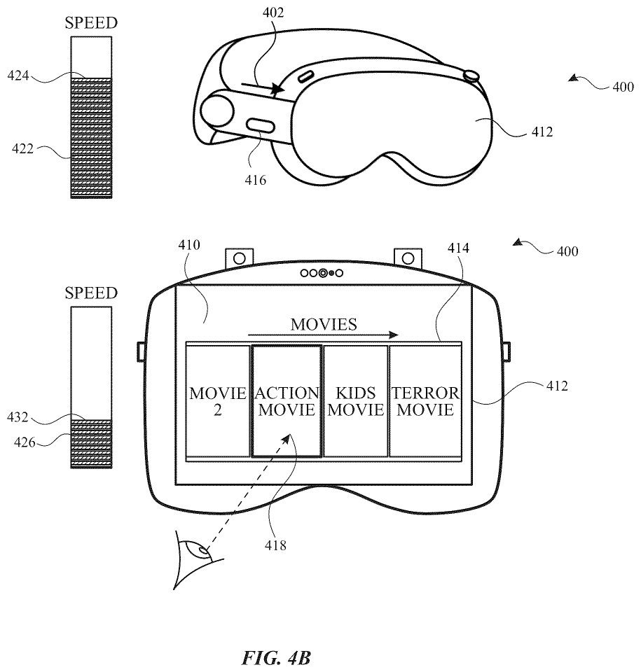

FIGS. 4A-4B illustrate an example of an electronic device 400 that features attention-based scroll stabilization according to examples of the disclosure. In some examples, the electronic device 400 is substantially similar to electronic devices 101, 201, and 300, previously described. As such, the electronic device 400 can be in communication with one or more displays and one or more input devices. For example, the electronic device 400 can be a head-mounted device (e.g., a head-mounted display) worn by a user of the electronic device 400. In some examples, electronic device 400 includes a display generation component 412 (e.g., display generation component 214 described above in reference to electronic device 201). In some examples, the electronic device 400 can present a three-dimensional environment 410 at display generation component (or display) 412. In some examples, three-dimensional environment 410 is visible to the user of electronic device 400 through display generation component 412 (e.g., optionally through a transparent and/or translucent display). For example, three-dimensional environment 410 is visible to the user of electronic device 400 while the user is wearing electronic device 400. In some examples, the display generation component is configured to display one or more virtual objects (e.g., virtual content included in a virtual window or a user interface) in three-dimensional environment 410. In some examples, the one or more virtual objects are displayed within (e.g., superimposed on) a virtual environment. In some examples, the one or more virtual objects are displayed within (e.g., superimposed on) a representation of a physical environment of a user. In some examples, the one or more virtual objects include one or more user interface elements, such as movie list 414. In some examples, the one or more user interface elements are scrollable, such as the scrollable movie list 414 displayed by the electronic device 400 in three-dimensional environment 410.

FIG. 4A illustrates an example scroll operation based on speed of a scroll input according to examples of the disclosure. In some examples, the electronic device 400 can detect via a first input device 416 of the one or more input devices, a scroll input 402. The scroll input 402 can correspond to a request to scroll the one or more user interface elements, such as scrollable movie list 414. It is understood that while the one or more user interface elements are shown in FIG. 4A as scrollable movie list 414, the one or more interface elements can be any scrollable interface element (e.g., any interface element that can scroll in response to user input (e.g., scroll input 402)). Examples of scrollable interface elements include content item interface (e.g., interfaces elements that includes pluralities of representation of content items such as videos, phots, documents, files), notifications interfaces, document interfaces, text, and other examples.

In some examples, the first input device 416 can be a physical user-interface device (e.g., touch sensitive surface described above in reference to electronic device 201), such as a touch-sensitive surface, a physical keyboard, a mouse, a joystick, a hand tracking device (e.g., hand tracking sensors 202 described above in reference to electronic device 201), an eye tracking device (e.g., eye tracking sensors 212 described above in reference to electronic device 201), a stylus, etc. In the example illustrated, the first input device 416 is touch-sensitive surface disposed on a surface of the electronic device 400. In some examples, the scroll input 402 can be a gesture input such as a swipe (e.g., by a finger or a stylus). In some examples, the swipe can correspond to a request to scroll the scrollable movie list 414 (e.g., the one or more interface elements) in a direction corresponding to (e.g., matching) a direction of the swipe. In some examples, the scroll input 402 (e.g., gesture swipe) can have a first input speed 424, as shown in input speed bar 422. Input speed 424 represents a speed of a gesture (e.g., a swipe gesture) detected by electronic device 400 as a scroll input 402.

In some examples, the one or more input devices can include one or more sensors for detecting eye movement (e.g., eye tracking sensors 212 described above in reference to electronic device 201) which can be used to determine attention or gaze position and/or gaze movement which can optionally be used to detect gaze-only inputs based on gaze movement and/or dwell. Gaze and/or attention information can be combined with hand tracking information to determine interactions between the user and one or more user interfaces based on direct and/or indirect inputs such as air gestures or inputs that use one or more hardware input devices such as one or more buttons.

In some examples, in response to detecting the scroll input 402 (e.g., the swipe), the electronic device 400 can scroll the one or more user interface elements such as the scrollable movie list 414. In particular, in accordance with a determination that attention of the user is not directed to the one or more user interface elements, the electronic device 400 can scroll the one or more user interface elements at a first speed 428. In some examples, attention is based on gaze 418, which indicates the location in the three-dimensional environment 410 where the electronic device 400 detects the gaze of the user as being directed (e.g., via one or more sensors of the one or more input devices). In FIG. 4A, attention (e.g., based on gaze 418) is shown as being directed to a location in the three-dimensional environment 410 other than the scrollable movie list 414. Accordingly, when user swipes or performs a swipe gesture on input device 416 (e.g., when the electronic device 400 detects the swipe gesture as a scroll input 402) while the scrollable movie list 414 is displayed in the three-dimensional environment 410, the electronic device 400 scrolls the movie list 414. In some examples, the electronic device 400 scrolls the one or more user interface elements at a first speed 428, as shown in speed bar 426. In some examples, the first speed 428 is a speed that is above a speed where a user can recognize or read the items of the movie list 414 due to the device determining that the user is not specifically directing their gaze to the movie list 414.

In some examples, such as described below, when the attention of the user shifts to the one or more user interface elements while the electronic device 400 detects a scroll input 402 (e.g., while the user is scrolling the one or more user interface elements), the electronic device 400 reduces the scroll speed even if the scroll input speed is maintained, in order to facilitate the user's view of the scrolling one or more user interface elements.

Accordingly, in some examples, in response to detecting the scroll input and in accordance with a determination that the attention of the user is directed to the one or more user interface elements, the electronic device 400 can scroll the one or more user interface elements at a second speed, slower than the first. FIG. 4B illustrates the electronic device 400 scrolling the one or more user interface elements (e.g., scrollable movie list 414) at a second speed 432 in response to scroll input 402 and in accordance with a determination that the attention of the user is directed to the one or more interface elements. As illustrated by input speed bar 422, the input speed 424 of the scroll input 402 in FIG. 4B is the same as input speed 424 of scroll input 402 shown in FIG. 4A. However, unlike in FIG. 4A, in FIG. 4B, attention of the user (e.g., based on gaze 418), is directed to the one or more interface elements (e.g., the user's gaze 418 is directed to scrollable movie list 414). Accordingly, in response to detecting the scroll input 402 and in accordance with the determination that the attention of the user (e.g., based on gaze 418) is directed to the scrollable movie list 414, the electronic device 400 scrolls the scrollable movie list 414 at a second speed 432, different from the first speed 428. In some examples, the electronic device 400 can scroll the scrollable movie list 414 at the second speed 432 despite the input speed 424 of the scroll staying the same as when the attention of the user (e.g., based on gaze 418) was not directed to the scrollable movie list 414. In some examples, such as illustrated in FIG. 4B, the second speed 432 is less or slower than the first input speed 424 (e.g., the scrolling slows down), thus effectively dampening the scroll input 402 and/or the effect of the swipe gesture and stabilizing the scroll when gaze 418 is directed at the one or more interface elements (e.g., attention-based scroll stabilization). Dampening and/or stabilizing the scroll input can facilitate the user's view of the scrolling one or more user interface elements when the attention of the user shifts to the one or more user interface elements while the electronic device 400 detects a scroll input 402 (e.g., while the user is scrolling the one or more user interface elements).

In some examples, the electronic device 400 reduces the scrolling speed based on a degree of attention directed to the one or more user interface elements. In one or more examples, a degree of attention reflects the extent which the user is focused on the one or more user interface elements, as detected by the electronic device 400. The degree of attention includes for example, eye movement while the gaze 418 is directed to the one or more user interfaces. For example, more eye movement can indicate that the user is less focused on the one or more user interface (e.g., a lower degree of attention) whereas less eye movement can indicate that the user is more focused on the one or more user interface elements (e.g., a higher degree of attention). In some examples, dwell can be a measure of a degree of attention, such that longer dwell can indicate a higher degree of attention and less dwell can indicate a lower degree of attention. Thus, in some examples, in accordance with a determination that a degree of the attention is a first degree, the electronic device 400 can scroll the one or more user interface elements at a first speed. In some examples, in accordance with a determination that the degree of the attention is a second degree, higher than the first, the electronic device can scroll the one or more user interface elements at a third speed, slower than the first.

Dampening a scroll input based on direction of gaze, such as for example, reducing the scroll speed of an interface element based on detecting that the gaze of the user is searching for a specific item as described above, reduces unnecessary motion in the user interface thus improving energy efficiency, and improves readability of the user interface, which enhances the efficiency of the user's interaction with the electronic device and minimizes the likelihood of erroneous user inputs, thereby preserving computing resources that would otherwise be expended to correct erroneous user inputs.

In some examples, a scroll input can be used to perform different actions based on the velocity (e.g., speed) of the scroll input. As described in further detail below, if a user is scrolling to navigate through a user interface, by increasing the velocity of the scroll input, the user can cause the electronic device to clear away user interface from their line as sight.

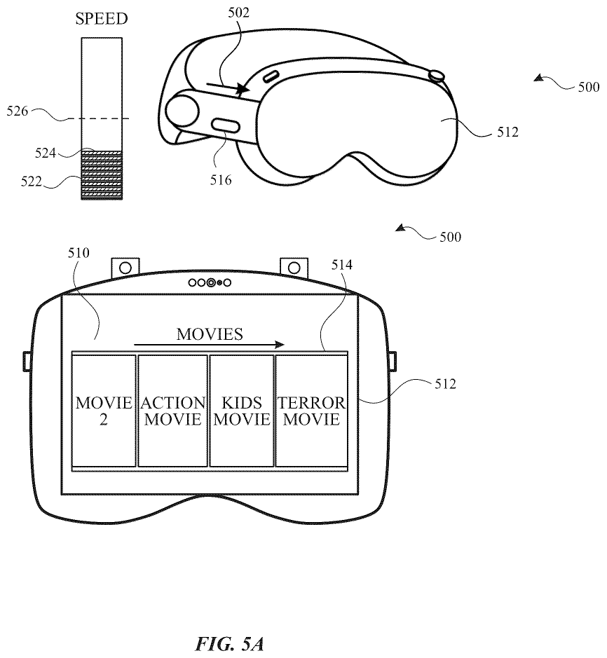

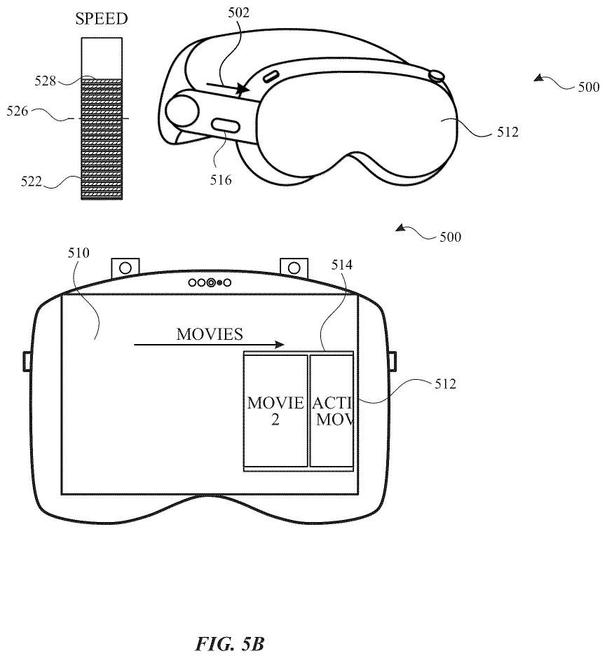

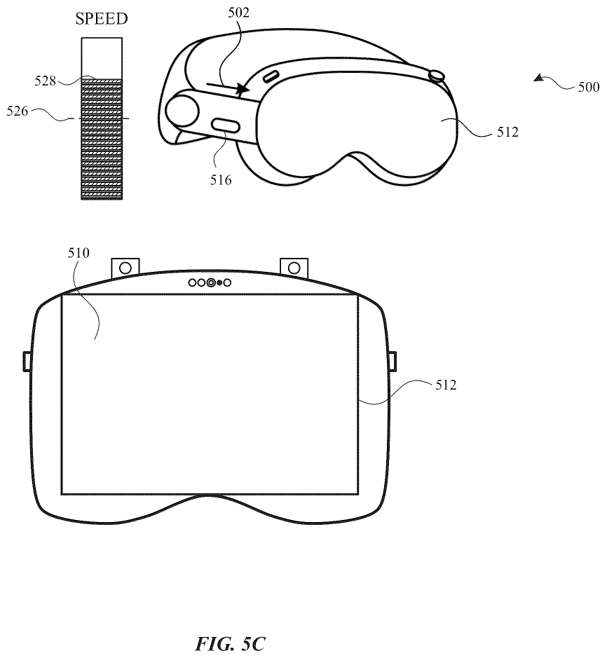

FIGS. 5A-5C illustrate an example of an electronic device 500 featuring velocity based-swipe detection according to examples of the disclosure. As illustrated in FIG. 5A, in some examples, the electronic device 500 is substantially similar to electronic devices 101, 201, 300, and 400, previously described. As such, the electronic device 500 can be in communication with one or more displays 512 (e.g., display generation component 214 described above in reference to electronic device 201) and one or more input devices 516. For example, the electronic device 500 can be a head-mounted device (e.g., a head-mounted display) worn by a user of the electronic device 500. In some examples, the electronic device 500 can present a three-dimensional environment 510 at display generation component (or display) 512.

In some examples, the electronic device 500 can detect, via a first input device of the one or more input devices 516, a scroll input 502. The scroll input 502 can correspond to a request to scroll the one or more user interface elements, such as scrollable movie list 514. It is understood that while the one or more user interface elements are shown in FIG. 5A as scrollable movie list 514, the one more interface elements can be any scrollable interface element (e.g., any interface element that can scroll in response to user input). Examples of scrollable interface elements include content item interface (e.g., interfaces that includes pluralities of representation of content items such as videos, phots, documents, files), notifications interfaces, document interfaces, and other examples.

In some examples, as illustrated in FIG. 5A, a first input device of the one or more input devices 516 can be a physical user-interface device, such as a touch-sensitive surface (e.g., touch sensitive surface described above in reference to electronic device 201), a physical keyboard, a mouse, a joystick, a hand tracking device (e.g., hand tracking sensors 202 described above in reference to electronic device 201), an eye tracking device (e.g., eye tracking sensors 212 described above in reference to electronic device 201), a stylus, etc. In the example illustrated, the first input device of the one or more input devices 516 is touch-sensitive surface disposed on a surface of the electronic device 500. In some examples, the scroll input 502 can be a gesture input such as a swipe (e.g., by a finger or a stylus). In some examples, the swipe can correspond to a request to scroll the scrollable movie list 514 (e.g., the one or more interface elements) in a direction corresponding to (e.g., matching) a direction of the swipe. In some examples, the scroll input (e.g., gesture swipe) can have a first input speed, shown as scroll input speed 524 in input speed bar 522. Scroll input speed 524 represents a speed of a gesture (e.g., a swipe gesture) detected by electronic device 500 as a scroll input.

In some examples, in response to detecting the scroll input 502 (e.g., the swipe), the electronic device 500 can scroll the one or more user interface elements such as the scrollable movie list 514. In particular, in accordance with a determination that the speed of the scroll input 502 is below an input speed threshold 526, the electronic device 500 can scroll the one or more user interface elements. As shown in FIG. 5A, the speed of the scroll input detected by the electronic device 500 is shown as scroll input speed 524 in scroll input speed bar 522. Further, scroll input speed 524 is below or less than input speed threshold 526. Accordingly, in response to detecting the scroll input 502 having a scroll input speed 524 below input speed threshold 526, the electronic device 500 scrolls the one or more user interface (e.g., scrollable movie list 514). In some examples, such as described in reference to electronic device 400 and illustrated in FIGS. 4A-4B, the electronic device 500 can scroll the one or more user interface at a first speed (e.g., first speed 428) and/or at a second speed (e.g., second speed 432) based on where the electronic device 500 detects that attention of the user is directed (e.g., based on gaze 418), and/or at a third speed based on the degree of attention directed to the one or more user interface elements.

In some examples, in accordance with a determination that the speed of the scroll input 502 (e.g., the swipe) is at or above the input speed threshold 526, the electronic device 500 can cease display of the one or more user interface elements as illustrated in the example of FIG. 5B. In one or more examples, FIG. 5B illustrates the electronic device detecting a scroll input 502. As with FIG. 5A, the scroll input 502 is a swipe gesture. However, unlike the scroll input 502 of FIG. 5A, the scroll input 502 of FIG. 5B has a speed 528 that is above input speed threshold 526 (e.g., the user swiped faster on the first input device of the one or more input devices 516 than in FIG. 5A, and with a speed that is above the input speed threshold 526). Accordingly, in response, the electronic device 500 ceases display of the one or more user interfaces (e.g., scrollable movie list 514). In some examples, the electronic device 500 ceases display of the one or more user interface elements (e.g., scrollable movie list 514) by displaying an animation of the one or more user interface element moving out of the three-dimensional environment 510. In some examples, the electronic device 500 displays the animation of the one or more user interface elements moving in a direction corresponding to a direction of the scroll input. In FIG. 5B, the one or more user interface elements (e.g., scrollable movie list 514) are displayed as moving out of a line of sight of the user and/or the three-dimensional environment 510. In FIG. 5C, the one or more user interface elements have been removed from the line of sight of the user and/or the three-dimensional environment 510. In particular, the electronic device 500 has ceased display of the one or more user interface elements (e.g., scrollable movie list 514) in the three-dimensional environment 510 in response to detecting a scroll input 502 whose scroll input speed 528 is above the input speed threshold 526.

In some examples, the scroll input 502 (e.g., a swipe gesture) whose speed is above the input speed threshold 526 and thus causes the electronic device 500 to cease display of the one or more user interface elements can have a direction matching a direction of a scroll input 502 (e.g., a swipe gesture) whose speed below the input speed threshold 526 causes the electronic device 500 to scroll the one or more user interface elements. Accordingly, a user can cause the electronic device 500 to cease to display of a user interface element they were scrolling with a scroll input 502 (e.g., a swipe gesture) by performing the same gesture (e.g., having the same direction) sufficiently fast to exceed the input speed threshold 526.

Performing different actions based on a speed of a scroll input such as described above, reduces the number of inputs required to operate the electronic device and thus improves navigation of the user interface, which enhances the efficiency of the user's interaction with the electronic device and preserves computing resources of the electronic device.

In one or more examples, in addition to inputs involving touch as described above, the user can also apply inputs to the electronic device using gaze. For example, and as described in detail below, the user can direct their gaze to a specific portion of the display to initiate an operation that is performed based on the context in which the gaze input is being applied.

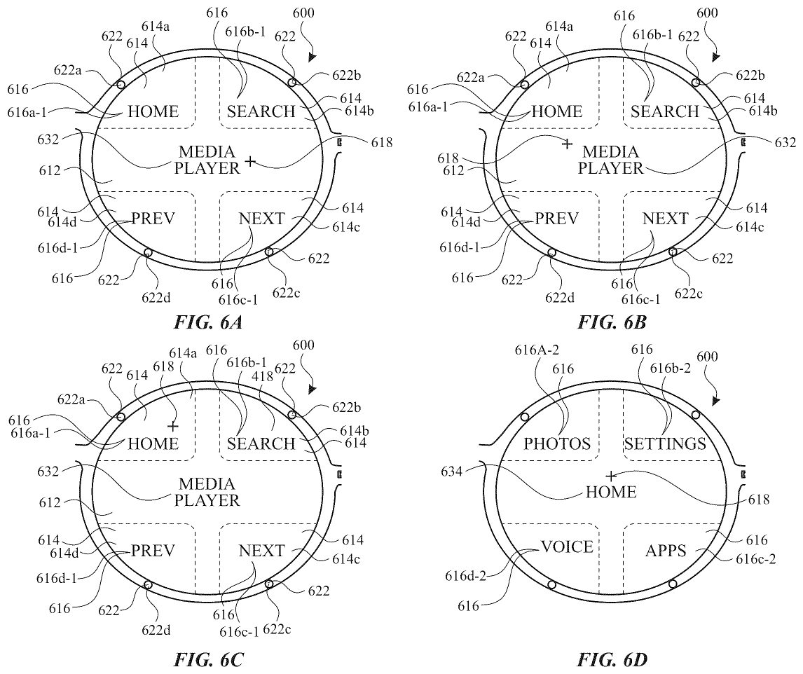

FIGS. 6A-6D illustrate an example of an electronic device 600 including context-driven active display regions according to examples of the disclosure. In some examples, the electronic device 600 is substantially similar to electronic devices 101, 201, 300, 400, and 500, previously described. As such, the electronic device 600 can be in communication with one or more displays 612 (e.g., display generation component 214 described above in reference to electronic device 201) and one or more input devices. For example, the electronic device 600 can be a head-mounted device (e.g., a head-mounted display) worn by a user of the electronic device 600. In some examples, the one or more displays 612 includes one or more regions 614. In FIG. 6A, the one or more displays 612 includes four regions 614 (614a, 614b, 614c, and 614d). However, it is understood that the one or more displays 612 of an electronic device 600 can feature any number of regions 614 (e.g., 1, 2, 3, 4, 5, 8, 10 and so on regions 614). In some examples, a region of the one or more regions 614 can correspond to a corner of the one or more displays 612. Such a region may be referred to as a “corner region.” In some examples, a region of the one or more regions 614 can correspond to an edge region, and may be referred to as an “edge region.” However, it is understood that a region can refer to any location on the one or more displays 612 of the electronic device 600 (e.g., a corner region, an edge region, a center region or any other region).

In some examples, the electronic device 600 further includes one or more visual indicators 622 (e.g., 622a, 622b, 622c, and 622d), each visual indicator 622 associated with a region 614 of the one or more regions 614. As described in reference to electronic device 201, a visual indicator 622 is an output device and one or more communication buses 208 are optionally used for communication between the one or more visual indicators 622 and other components of the electronic device 600. In some examples, a visual indicator 622 is a light emitting diode (“LED”). In some examples, such as illustrated in FIGS. 6A-6D, a region 614 is located adjacent the visual indicator 622 (e.g., LED) with which it is associated. In some examples, the electronic device 600 can change characteristics (e.g., brightness, color) of a visual indicator 622 (e.g., LED) based on detecting attention directed to the corresponding region 614, as will be described further below.

In some examples, the electronic device 600 can present first context at the one or more displays 612. In some examples, a context at the electronic device 600 can include an environment presented at the display, such as a three-dimensional environment as described in reference to electronic devices 400 and 500 and shown in FIGS. 4A-4B and FIGS. 5A-5C (e.g., three-dimensional environments 410 and 510). In some examples, the context can include a location of the user within the three-dimensional environment and/or the virtual objects displayed in the three-dimensional environment. In some examples, the context can include an event or occurrence within the three-dimensional environment. In some examples, the context can include one or more applications the electronic device 600 presents at the one or more displays 612. In some examples, the context can include one or more user interfaces the electronic device 600 presents at the one or more displays 612. In some examples, the context can include the physical environment of the electronic device 600, as detected via the various sensors of the electronic device 600, such as described above in reference to electronic device 201 (e.g., one or more hand tracking sensors 202, one or more location sensors 204, one or more image sensors 206, one or more touch-sensitive surfaces 209, one or more motion and/or orientation sensors 210, one or more eye tracking sensors 212, one or more microphones 213 or other audio sensors, one or more body tracking sensors (e.g., torso and/or head tracking sensors)). For example, the context can include the electronic device 600 detecting via the one or more image sensors 206 that the user is indoors and not outside, or that the user is watching television or reading a book. For example, the context can include the electronic device detecting via the one more body tracking sensors that the user is standing up or sitting down.

In some examples, in accordance with a determination that a first context is present at the electronic device 600, the electronic device 600 can display in a region of the one or more regions 614, an indication 616 corresponding to an operation to be performed at the electronic device 600. As will be described further below, the corresponding operation can be performed when the electronic device 600 detects attention directed to the region 614. As shown in FIG. 6A, the electronic device 600 is displaying a media player interface 632 in the three-dimensional environment, which constitutes a context (e.g., the first context) being present at the electronic device 600. In accordance with the first context including the media player interface 632, the electronic device 600 displays in the first region (e.g., region 614a) a first indication 616a-1 (e.g., “home”) corresponding to a first operation to be performed at the electronic device (e.g., display the home screen). In some examples, such as illustrated, in accordance with the first context including the media player interface 632, the electronic device 600 can display in multiple regions 614 (e.g., 614a-614d) first indications 616 (e.g., 616a-1, 616b-1, 616c-1, and 616d-1) corresponding to first operations to be performed at the electronic device 600. In some examples, the electronic device optionally does not display an indication 616 in region 614 despite that region 614 corresponding to an operation to be performed at the electronic device.

Each indication 616n-1 is associated with a region 614n of the one or more regions 614. The indications 616 thus serves to notify the user of which operation will be performed if they direct attention to a particular region 614. In some examples, such as illustrated, an indication 616 can be a label naming the operation corresponding to the region (e.g., “home,” “search,” etc.). In some examples, the indication 616 can be an icon illustrating and/or corresponding to the operation associated with the region 614.

In accordance with a determination that a first context (e.g., the media player interface 632) is present at the electronic device 600, and an attention of the user is directed to a first region 614 of the plurality of regions 614, the electronic device 600 can perform a first operation at the electronic device. In some examples, attention is based on gaze 618, which indicates the location of the one or more displays 612 where the electronic device 600 detects the gaze of the user as being directed (e.g., via one or more sensors of the one or more input devices). In FIG. 6A, gaze 618 is shown as being directed to media player interface 632 and away from any of the regions 614a-614d. In FIG. 6B, gaze 618 is shown as being directed closer to region 614a without being directed to the region itself. In FIG. 6C, gaze 618 is shown as being directed to region 614a and electronic device 600 detects that attention (e.g., based on gaze 618) is directed to the to the region 614a. Region 614a includes indication 616a (e.g., “home”) which indicates that the operation corresponding to the region 614a is a request to display the home interface or home screen of the electronic device 600. Accordingly, as shown in FIG. 6D, in response to detecting that an attention of the user (e.g., based on gaze 618) is directed to region 614a (e.g., the first region), the electronic device 600 performs the “home” operation (e.g., the first operation) at the electronic device and thus displays the home screen 634.

Further, in FIG. 6D, the home screen 634 represents a second context present at the electronic device 600 different from the first context of the media player interface 632. Therefore, in some examples, in accordance with a determination that the second context, different from the first context, is present at the electronic device 600, the electronic device 600 can display in the first region (e.g., region 614a) a second indication 616a-2 (e.g., “photos”), different from the first indication 616a-1 (e.g., “home” as shown in FIGS. 6A-6C), and corresponding to a second operation (e.g., open a photos app). In some examples, the electronic device 600 can display in multiple regions 614 (e.g., 614a-614d) second indications 616 (e.g., 616a-2, 616b-2, 616c-2, and 616d-2 or respectively “photos,” “settings,” “voice” or “voice assistant,” and “apps”), different from the first indications, and corresponding to second operations to be performed at the electronic device, different from the first operations.

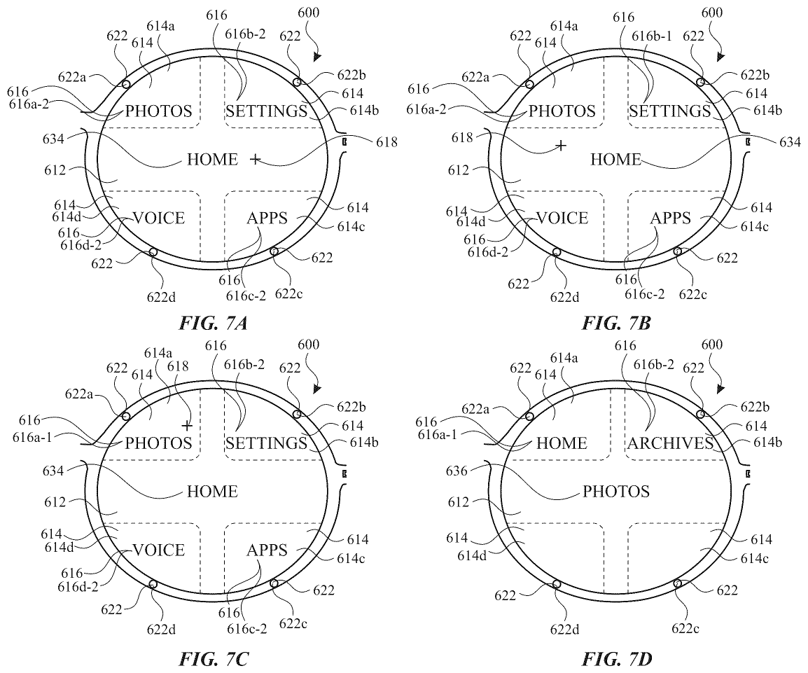

FIGS. 7A-7D illustrate an example of an electronic device 600 including context-driven active display regions according to examples of the disclosure. In FIG. 7A, a second context (e.g., a context including home screen 634) is present at the electronic device 600, which is the same context as presented in FIG. 6D. In accordance with a determination that the second context (e.g., home screen 634) is present at the electronic device 600, and an attention of the user is directed to first region 614a of the plurality of regions 614, the electronic device 600 can perform a second operation at the electronic device (e.g., open the photos app), different from the first operation (e.g., display the home interface). In FIG. 7A, as gaze 618 is detected as being directed to the home screen 634 and away from any of the regions 614a-614d. In FIG. 7B, gaze 618 is shown as being directed closer to region 614a without being directed to the region itself. In FIG. 7C, gaze 618 is shown as being directed to region 614a and electronic device 600 detects that attention (e.g., based on gaze 618) is directed to the region 614a. Region 614a includes indication 616a-2 (e.g., “photos”), which is different from indications 616a-1 (“home”) of the first context (e.g., media player interface 632) and indicates that the operation corresponding to the region 614a in the second context is opening the photos app. Accordingly, as shown in FIG. 7D, in response to detecting that an attention of the user (e.g., based on gaze 618) is directed to region 614a (e.g., the first region), the electronic device 600 performs the “photos” operation (e.g., the second operation) at the electronic device and thus opens the photos app.

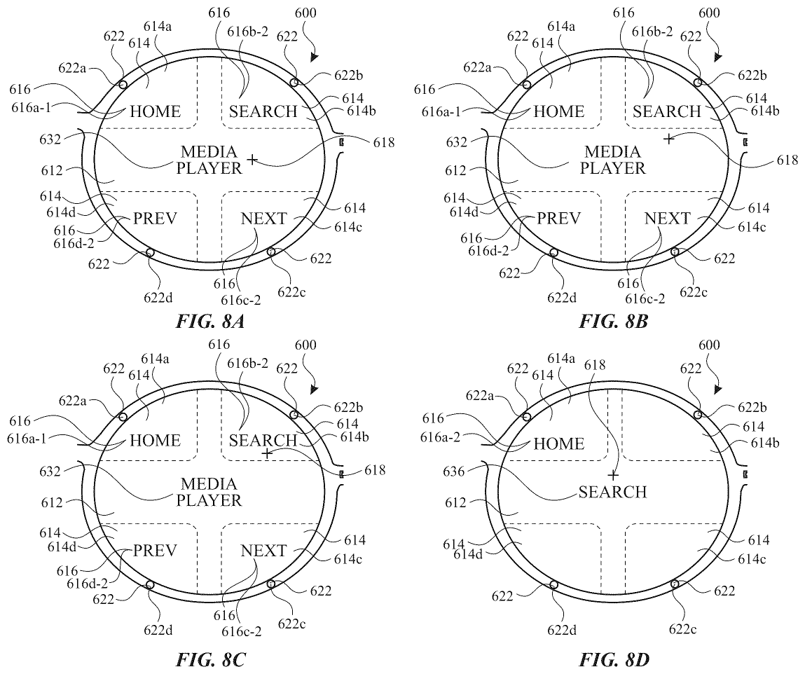

FIGS. 8A-8D illustrate an example of an electronic device 600 including context-driven active display regions according to examples of the disclosure. In FIG. 8A, the first context is present at electronic device 600, which is the same context as in FIGS. 6A-6C (e.g., a context including media player interface 632) and displays the same indications 616a-1-616d-1 (e.g., “home,” “search,” “prev,” “next”) in the one more regions 614a-614d of the one or more displays 612. In accordance with a determination that the first context (e.g., the media player interface 632) is present at electronic device 600, and an attention of the user is directed to a second region 614b of the plurality of regions 614, the electronic device 600 can perform a third operation at the electronic device (e.g., display the settings) different from the first operation (e.g., “home” operation). In FIG. 8A, as gaze 618 is detected as being directed to media player interface 632 and away from any of the regions 614a-614d. In FIG. 8B, gaze 618 is shown as being directed closer to region 614b without being directed to the region itself. In FIG. 8C, gaze 618 is shown as being directed to region 614b and electronic device 600 detects that attention (e.g., based on gaze 618) is directed to the to the region 614b. Region 614b includes indication 616b-1 (e.g., “search”), which is different from the indication 616a-1 (“home”) and indicates that the operation corresponding to the region 614b is a request to display the search interface of the media player interface 632. Accordingly, as shown in FIG. 8D, in response to detecting that an attention of the user (e.g., based on gaze 618) is directed to region 614b (e.g., the second region), the electronic device 600 performs the “search” operation (e.g., the third operation) at the electronic device and thus displays the search interface 636.

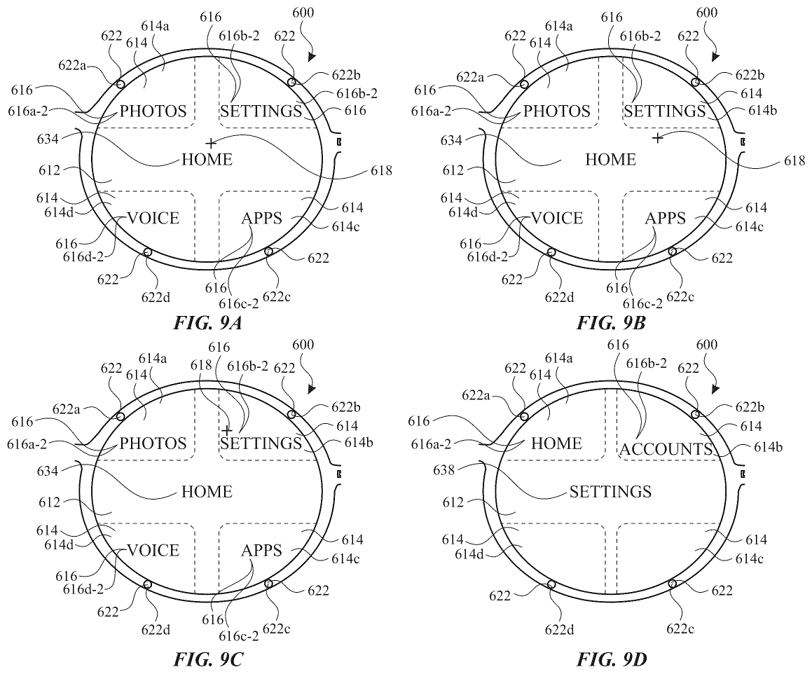

FIGS. 9A-9D illustrate an example of an electronic device 600 including context-driven active display regions according to examples of the disclosure. In FIG. 9A, the second context (e.g., a context including home screen 634) is present at electronic device 600, which is the same context as in FIGS. 7A-7C (e.g., a context including home screen 634) and displays the same indications 616a-2-616d-2 (e.g., “photos,” “settings,” “voice” or “voice assistant,” “apps”) in the one more regions 614a-614d of the one or more displays 612. In accordance with a determination that the second context (e.g., home screen 634) is present at electronic device 600, and an attention of the user is directed to second region 614b of the plurality of regions 614, the electronic device 600 can perform a fourth operation at the electronic device (e.g., display settings interface), different from the second operation (e.g., open the photos app). In FIG. 9A, as gaze 618 is shown as being directed to the home screen 634 and away from any of the regions 614a-614d. In FIG. 9B, gaze 618 is shown as being directed closer to region 614b without being directed to the region itself. In FIG. 9C, gaze 618 is shown as being directed to region 614b and electronic device 600 detects that attention (e.g., based on gaze 618) is directed to the region 614b. Region 614b includes indication 616b-2 (e.g., “settings”), which is different from indication 616a-2 (e.g., “search”) of the first context (e.g., media player interface 632) and indicates that the operation corresponding to the region 614b is displaying the settings interface. Accordingly, as shown in FIG. 9D, in response to detecting that an attention of the user (e.g., based on gaze 618) is directed to region 614b (e.g., the second region), the electronic device 600 performs the “settings” operation (e.g., the fourth operation) at the electronic device and thus displays the settings interface 638.

In some examples, while detecting that a gaze of a user is in proximity of a region 614, the electronic device 600 can change visual characteristics (e.g., brightness and/or color) of a visual indicator 622 associated with that region to provide feedback to the user. For example, the electronic device 600 can vary a brightness of a visual indicator 622 associated with a region 614 based on a distance of the gaze 618 of the user from the region. In some examples, when the gaze 618 of the user is detected within a region 614, the electronic device 600 can change the color of the corresponding visual indicator 622 based on the operation associated with region.

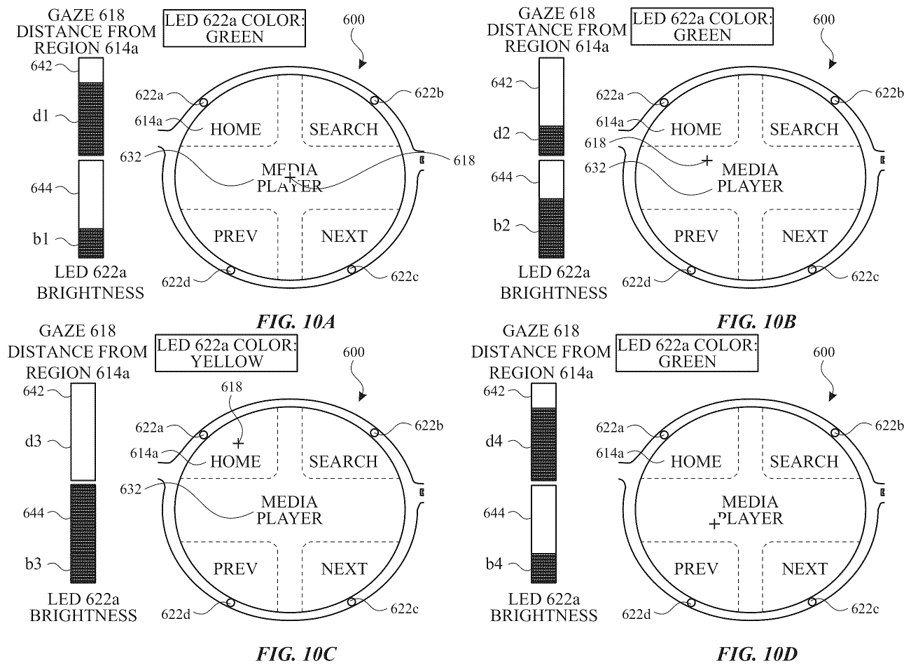

FIGS. 10A-10D illustrate an example of an electronic device 600 including context-driven active display regions according to examples of the disclosure. In FIG. 10A, the first context is present at electronic device 600, which is the same context as in FIGS. 6A-6C (e.g., a context including media player interface 632) and displays the same indications 616a-1-616d-1 (e.g., “home,” “search,” “prev,” “next”) in the one more regions 614a-614d of the one or more displays 612. As previously described, the electronic device 600 further includes one or more visual indicators 622 (e.g., 622a, 622b, 622c, and 622d), each visual indicator 622 associated with a region 614 of the one or more regions 614. In some examples, the electronic device can vary the brightness of a visual indicator 622 based on a distance of the gaze 618 of the user from the region 614 corresponding to the visual indicator. Accordingly, as shown in FIG. 10A, in accordance with a determination that the gaze 618 of the user is a first distance d1 (as shown in distance indicator 642) from the first region 614a, the electronic device 600 can set the first visual indicator 622 (e.g., LED 622a) to the first brightness b1. As shown in FIG. 10B, in accordance with a determination that the gaze 618 of the user is a second distance d2 from the first region 614a, less than the first distance d1, the electronic device 600 can set the first visual indicator to a second brightness b2, greater than the first brightness b1. The electronic device 600 can thus illuminate the visual indicator (e.g., LED 622) with a greater brightness when the gaze 618 of the user approaches the region 614 corresponding to the visual indicator (e.g., LED 622).

Further, the electronic device can reduce the brightness of a LED 622n when the gaze 618 moves away from region 614n associated with the LED 622n. For example, as shown in FIG. 10D, in accordance with a determination that the gaze 618 of the user is a distance d4 from the first region 614a greater than distance d1, the electronic device 600 can set the first visual indicator (e.g., LED 622a) to a brightness b4, less than the first brightness b1. The electronic device 600 can thus illuminate the LED 622n with less brightness when the gaze 618 of the user moves away from the region 614n corresponding to the LED 622n.

In some examples, in accordance with the determination that the attention of the user is directed to the first region (e.g., region 614a), the electronic device changes a brightness 644 of the first visual indicator (e.g., LED 622a) from a first brightness to a second brightness, greater than the first brightness. As shown in FIG. 10A, the attention of the user (e.g., based on gaze 618) is not directed at a region 614 (e.g., region 614a). Accordingly, the brightness 644 of LED 622a is at b1. In FIG. 10C, where the attention of the user (e.g., based on gaze 618) is directed to the region 614a, the brightness of LED 622a is shown at b3, which is a higher brightness than b1. The electronic device 600 thus increases the brightness of LED 622a when attention (e.g., based on gaze 618) is directed to region 614a associated with LED 622a. Similarly, in accordance with a determination that attention (e.g., based on gaze 618) is directed to any of region 614a-614d, the electronic device 600 can increase the brightness of the visual indicator 622 (e.g., LED 622a-622d) associated with the region to which the attention is directed.

Further, in some examples, a color of visual indicator (e.g., LED 622a) changes when the electronic device 600 detects that attention (e.g., based on gaze 618) is directed to the corresponding region (e.g., region 614a). Therefore, in accordance with the determination that the first context is present at electronic device 600, and the attention of the user is directed to the first region of the plurality of regions, the electronic device 600 changes the color of the first visual indicator from a first color to a second color. For example, as shown in FIGS. 10A and 10B, where the electronic device presents a first context (e.g., a context that includes media player interface 632) and the gaze 618 of the user is not directed to region 614a, the electronic device 600 sets the color of LED 622a associated with the region 614a to green (e.g., the first color). In FIG. 10C, where the gaze 618 of the user is directed to the region 614a, the electronic device 600 sets the color of LED 622a associated with the region 614a to yellow (e.g., the second color).

In some examples, the color of a visual indicator 622 can change with the corresponding operation (which as previously described, can change based on the context). Therefore, in accordance with the determination that the second context is present at electronic device 600, and the attention of the user is directed to the first region of the plurality of regions, the electronic device can change the color of the first visual indicator to a third color, different from the second color. For example, the electronic device 600 can change a color of the first visual indicator (e.g., LED 622a) to blue (a third color) in accordance with a determination that the second context (e.g., the home screen 634 such as shown in FIGS. 7A-7C) is present at electronic device 600, and the attention of the user (e.g., based on gaze 618) is directed to the first region 614a of the plurality of regions.

Displaying context-driven indications of actions and performing context-driven actions based on detected gaze in a region of the display as described above reduces the number of inputs and/or input types required to operates the electronic device and thus improves navigation and flexibility of the user interface, which enhances the efficiency of the user's interaction with the electronic device and preserves computing resources of the electronic device.

It is understood that although the different features described above are described separately in reference to different electronic devices, in some examples, some and/or all of the described features can be implemented together in the same electronic device.

It is understood that the examples shown and described herein are merely exemplary and that additional and/or alternative elements may be provided within the three-dimensional environment for automatically adjusting an input detected at an intelligent input device to accomplish user intent even when the input is already assigned to another action, dampening a scroll input based on direction of gaze, performing different actions based on a speed of the scroll input, and/or displaying context-driven indications of actions that can be performed when gaze is detected at the indications. It should be understood that the appearance, shape, form, and size of each of the various user interface elements and objects shown and described herein are exemplary and that alternative appearances, shapes, forms and/or sizes may be provided. For example, the virtual objects representative of application user interfaces (e.g., media player interface 314) may be provided in alternative shapes than those shown, such as a rectangular shape, circular shape, triangular shape, etc. In some examples, the various selectable affordances (e.g., first and second selectable options 324 and 326, and/or movie lists 414 and 514) described herein may be selected verbally via user verbal commands (e.g., “select option” or “select virtual object” verbal command). Additionally or alternatively, in some examples, the various options, user interface elements, control elements, etc. described herein may be selected and/or manipulated via user input received via one or more input devices in communication with the electronic device (or electronic devices). For example, selection input may be received via physical input devices, such as a mouse, trackpad, keyboard, etc. in communication with the electronic devices (or electronic devices), or a physical button integrated with the electronic devices (or electronic devices).

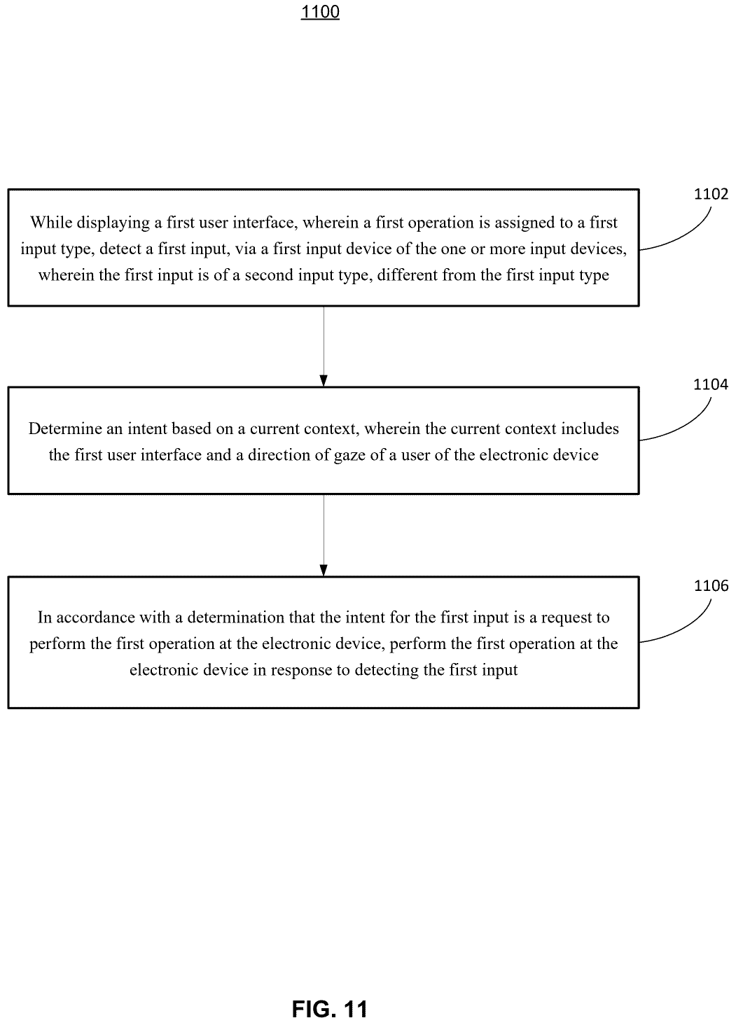

FIG. 11 illustrates an example flowchart of a method 1100 according to an example of the disclosure. In some examples, method 1100 begins at an electronic at an electronic device in communication with one or more displays and one or more input devices. In some examples, the electronic device is a head mounted display similar or corresponding to electronic device 101 of FIG. 1 and/or electronic device 201 of FIG. 2A. As shown in FIG. 11, in some examples, while displaying a first user interface, wherein a first operation is assigned to a first input type, the electronic device detects (1102) a first input, via a first input device of the one or more input devices, wherein the first input is of a second input type, different from the first input type. For example, while displaying a media player interface 314, wherein a “pause” operation is assigned to tap input (e.g., to pause playback), the electronic device (e.g., electronic device 300) can detect a double tap input via touch-sensitive surface 316, as shown in FIG. 3B.

In some examples, the electronic device determines (1104) an intent based on a current context, wherein the current context includes the first user interface and a direction of gaze of a user of the electronic device. For example, the current context can include the media player interface 314 and direction of gaze 318, as shown in FIGS. 3A and 3B.

In some examples, in accordance with a determination that the intent for the first input is a request to perform the first operation at the electronic device, the electronic device performs (1106) the first operation at the electronic device in response to detecting the first input. For example, as shown in FIG. 3B, the electronic device 300 can determine that the intent for the double tap input is a request to perform the “pause” operation at the electronic device (e.g., instead of the “clear UI” operation assigned to the double tap input). In accordance with the determination that the intent of the double tap input is a request to perform the “pause” operation, the electronic device 300 can perform the “pause” operation (e.g., pause playback) in response to detecting the double tap input, thus overring the input assignment or mapping of the double tap input (e.g., “clear UI”) based on the context of the electronic device 300.

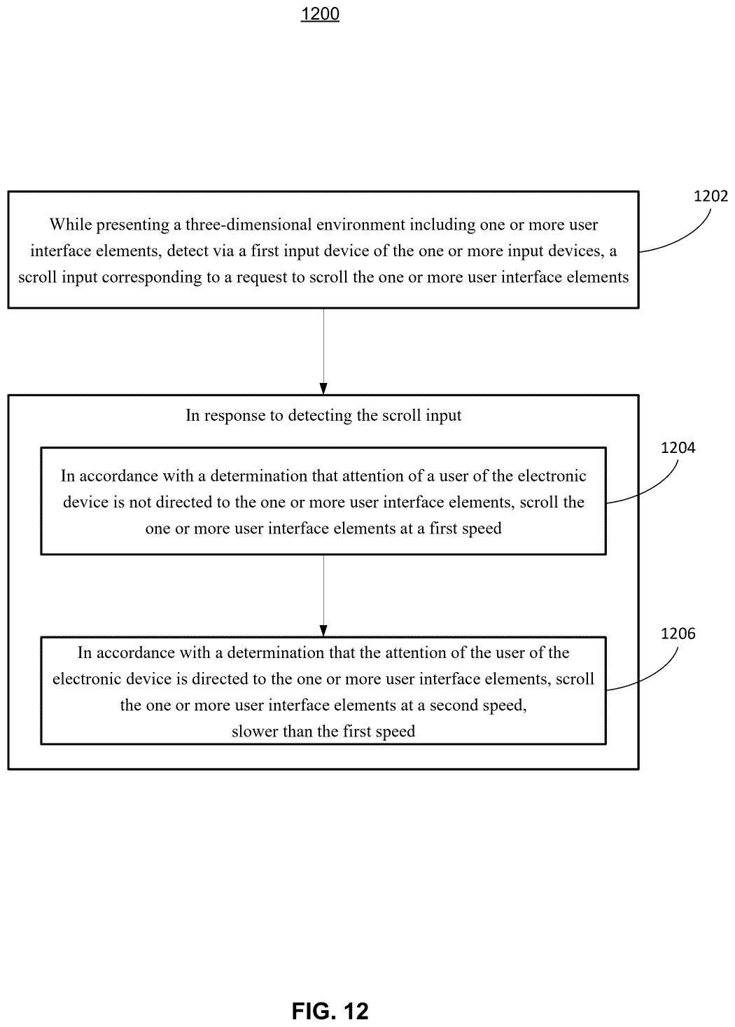

FIG. 12 illustrates an example flowchart of a method 1200 according to an example of the disclosure. In some examples, method 1200 begins at an electronic device in communication with one or more displays and one or more input devices. In some examples, the electronic device is a head mounted display similar or corresponding to electronic device 101 of FIG. 1 and/or electronic device 201 of FIG. 2A. As shown in FIG. 12, in some examples, while presenting a three-dimensional environment including one or more user interface elements, the electronic device detects (1202) via a first input device of the one or more input devices, a scroll input corresponding to a request to scroll the one or more user interface elements. For example, as shown in FIGS. 4A and 4B, the electronic device 400 detects via one or more input devices (e.g., touch-sensitive surface 416) a scroll input 402 (e.g., a swipe gesture) corresponding to a request to scroll movie list 414.

In some examples, in response to detecting the scroll input, in accordance with a determination that attention of a user of the electronic device is not directed to the one or more user interface elements, the electronic device can scroll (1204) the one or more user interface elements at a first speed. As shown in FIG. 4A, in some examples, attention is based on gaze, such as gaze 418 of the user. In accordance with a determination that gaze 418 of the user of the electronic device is not directed to the movie list 414, the electronic device 400 scrolls the movie list 414 at a first scroll speed 428.

In some examples, in accordance with a determination that the attention of the user of the electronic device is directed to the one or more user interface elements, the electronic device scrolls (1206) the one or more user interface elements at a second speed, slower than the first speed. As shown in FIG. 4B, in accordance with a determination that gaze 418 of the user of the electronic device is not directed to the movie list 414, the electronic device 400 scrolls the movie list 414 at a second scroll speed 432, slower than the first scroll speed 428.

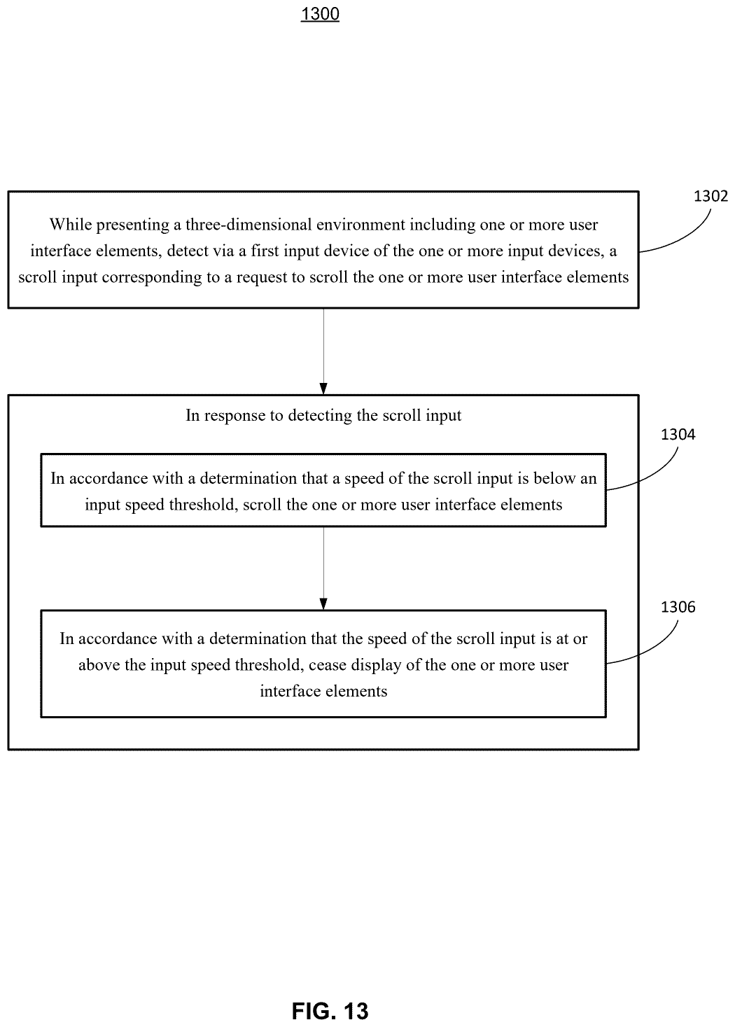

FIG. 13 illustrates an example flowchart of a method 1300 according to an example of the disclosure. In some examples, method 1300 begins at an electronic device in communication with one or more displays and one or more input devices. In some examples, the electronic device is a head mounted display similar or corresponding to electronic device 101 of FIG. 1 and/or electronic device 201 of FIG. 2A. As shown in FIG. 13, in some examples, while presenting a three-dimensional environment including one or more user interface elements, the electronic device detects (1302) via a first input device of the one or more input devices, a scroll input corresponding to a request to scroll the one or more user interface elements. For example, as shown in FIGS. 5A-5C, the electronic device 500 detects via the one or more input devices (e.g., touch-sensitive surface 516) a scroll input 502 (e.g., a swipe gesture) corresponding to a request to scroll movie list 514.

In some examples, in response to detecting the scroll input, in accordance with a determination that a speed of the scroll input is below an input speed threshold, the electronic device scrolls (1304) the one or more user interface elements. For example, as shown in FIG. 5A, in accordance with a determination that speed 524 of the scroll input 502 (e.g., a swipe gesture) is below an input speed threshold 526, the electronic device 500 scrolls movie list 514.

In some examples, in response to detecting the scroll input, in accordance with a determination that the speed of the scroll input is at or above the input speed threshold, the electronic device ceases (1306) display of the one or more user interface elements. For example, as shown in FIG. 5B-5C, in accordance with a determination that speed 528 of the scroll input 502 (e.g., a swipe gesture) is at or above the input speed threshold 526, the electronic device 500 ceases display of movie list 414. In FIG. 5B, the electronic device 500 ceases display of movie list 414 by scrolling the movie list 414 out of the (right side of) one of more displays 512. In FIG. 5C, the electronic device 500 has ceases display of the movie list 514.

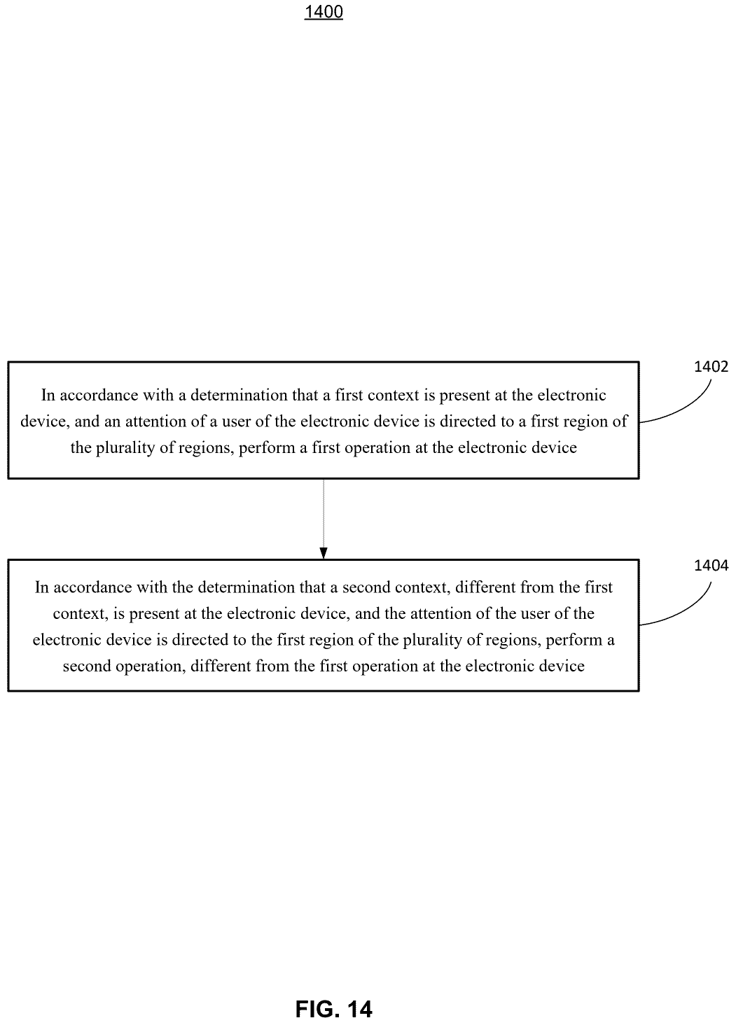

FIG. 14 illustrates an example flowchart of a method 1300 according to an example of the disclosure. In some examples, method 1400 begins at an electronic device in communication with one or more displays having a plurality of regions and one or more input devices. In some examples, the electronic device is a head mounted display similar or corresponding to electronic device 101 of FIG. 1 and/or electronic device 201 of FIG. 2A. As shown in FIGS. 6A-6D, a region 614 of the plurality of regions can correspond to a corner of the one or more displays 612.

In some examples, in accordance with a determination that a first context is present at the electronic device, and an attention of a user of the electronic device is directed to a first region of the plurality of regions, the electronic device performs (1402) a first operation at the electronic device. As shown in FIGS. 6A-6C, in some examples, the first context can include a user interface such a media player interface 632. In some examples, the attention of the user is based on gaze 618 of the user, which in FIG. 6C, is directed to region 614a where indication 616a-1 (e.g., “home”) is displayed. In FIG. 6D, the electronic device 600 performs the first operation (e.g., displaying home screen 634) corresponding to the region 614a (e.g., “home”) from FIG. 6C.

In some examples, in accordance with the determination that a second context, different from the first context, is present at the electronic device, and the attention of the user of the electronic device is directed to the first region of the plurality of regions, the electronic device performs (1404) a second operation, different from the first operation at the electronic device. As shown in FIGS. 7A-7C, in some examples, the second context can include home screen 634, which is different from media player interface 632. Accordingly, as shown by indication 616a-2, the second operation (e.g., “photos”) corresponding to region 614a is different from the first operation (e.g., “home”). In FIG. 7C, gaze 618 of the user is directed to region 614a and in FIG. 7D, the electronic device 600 performs the second operation (e.g., opens the photos app) corresponding to the region 614a (e.g., “photos”) from FIG. 7C.

It is understood that processes or methods 1100, 1200, 1300, and 1400 are examples and that more, fewer, or different operations can be performed in the same or in a different order (e.g., in a process). Additionally, the operations in processes or methods 1100, 1200, 1300, and 1400 described above are, optionally, implemented by running one or more functional modules in an information processing apparatus such as general-purpose processors (e.g., as described with respect to FIGS. 2A-2B) or application specific chips, and/or by other components of FIGS. 2A-2B.

Therefore, according to the above, some examples of the disclosure are directed to a method including, at an electronic device in communication with one or more displays and one or more input devices: while displaying a first user interface, wherein a first operation is assigned to a first input type, detecting a first input, via a first input device of the one or more input devices, wherein the first input is of a second input type, different from the first input type; determining an intent based on a current context, wherein the current context includes the first user interface and a direction of gaze of a user of the electronic device; and in accordance with a determination that the intent for the first input is a request to perform the first operation at the electronic device: performing the first operation at the electronic device in response to detecting the first input. Additionally or alternatively to one or more of the examples disclosed above, in some examples, the method can further include, in accordance with a determination that the intent for the first input is not a request to perform the first operation, displaying a second user interface including a first selectable option for performing the first operation and a second selectable option for performing a second operation, different than the first operation. Additionally or alternatively to one or more of the examples disclosed above, in some examples, the method can further include detecting a second input directed to the first or second selectable option and in response, in accordance with a determination that the second input is directed to the first selectable option, performing the first operation at the electronic device, and in accordance with a determination that the second input is directed to the second selectable option, performing the second operation at the electronic device. Additionally or alternatively to one or more of the examples disclosed above, in some examples, determining the intent can include determining a confidence level associated with the intent, and in accordance with a determination that the confidence level is above a confidence threshold, performing the first operation at the electronic device. Additionally or alternatively to one or more of the examples disclosed above, in some examples, the method can further include, in accordance with a determination that the confidence level does not exceed the confidence threshold, displaying a second user interface including a first selectable option for performing the first operation and a second selectable option for performing a second operation.

According to the above, some examples of the disclosure are directed to a method including, at an electronic device in communication with one or more displays and one or more input devices: while presenting a three-dimensional environment including one or more user interface elements, detecting via a first input device of the one or more input devices, a scroll input corresponding to a request to scroll the one or more user interface elements; and in response to detecting the scroll input: in accordance with a determination that attention of a user of the electronic device is not directed to the one or more user interface elements, scrolling the one or more user interface elements at a first speed; and in accordance with a determination that the attention of the user of the electronic device is directed to the one or more user interface elements, scrolling the one or more user interface elements at a second speed, slower than the first speed. Additionally or alternatively to one or more of the examples disclosed above, in some examples, the attention of the user can include a gaze of the user and wherein the determination that the attention of the user is directed to the one or more user interface elements includes a determination that the gaze of the user is directed to the one or more user interface elements. Additionally or alternatively to one or more of the examples disclosed above, in some examples, the method can further include, in accordance with a determination that a degree of the attention is a first degree, scrolling the one or more user interface elements at the second speed; and in accordance with a determination that a degree of the attention is a second degree, higher than the first degree, scrolling the one or more user interface elements at a third speed, slower than the first speed.

According to the above, some examples of the disclosure are directed to a method including, at an electronic device in communication with one or more displays and one or more input devices: while presenting a three-dimensional environment including one or more user interface elements, detecting via a first input device of the one or more input devices, a scroll input corresponding to a request to scroll the one or more user interface elements; and in response to detecting the scroll input: in accordance with a determination that a speed of the scroll input is below an input speed threshold, scrolling the one or more user interface elements; and in accordance with a determination that the speed of the scroll input is at or above the input speed threshold, ceasing display of the one or more user interface elements. Additionally or alternatively to one or more of the examples disclosed above, in some examples, the scroll input can include a swipe gesture. Additionally or alternatively to one or more of the examples disclosed above, in some examples, the scroll input having a speed below the input speed threshold can be a first scroll input and the scroll input having a speed at or above the input speed threshold can be a second scroll input and a direction of the first scroll input can correspond to a direction of the second scroll input. Additionally or alternatively to one or more of the examples disclosed above, in some examples, ceasing display of the one or more user interface elements can included displaying an animation of the one or more user interface elements moving in a direction of the scroll input.

According to the above, some examples of the disclosure are directed to a method including: at an electronic device in communication with one or more displays having a plurality of regions and one or more input devices: in accordance with a determination that a first context is present at the electronic device, and an attention of a user of the electronic device is directed to a first region of the plurality of regions, performing a first operation at the electronic device; and in accordance with the determination that a second context, different from the first context, is present at the electronic device, and the attention of the user of the electronic device is directed to the first region of the plurality of regions, performing a second operation, different from the first operation at the electronic device. Additionally or alternatively to one or more of the examples disclosed above, in some examples, the method can further include: in accordance with a determination that the first context is present at the electronic device, and the attention of the user is directed to a second region of the plurality of regions, performing a third operation, different from the first operation, at the electronic device; and in accordance with the determination that the second context is present at the electronic device, and the attention of the user is directed to the second region of the plurality of regions, performing a fourth operation, different from the second operation, at the electronic device. Additionally or alternatively to one or more of the examples disclosed above, in some examples, the method can further include in accordance with a determination that the first context is present at the electronic device, displaying in the first region a first indication corresponding to the first operation, and in accordance with the determination that the second context is present at the electronic device, displaying in the first region a second indication, different from the first indication, and corresponding to the second operation. Additionally or alternatively to one or more of the examples disclosed above, in some examples, the electronic device can include a first visual indicator associated with the first region, and the method can further include in accordance with the determination that the attention of the user is directed to the first region, changing a brightness of the first visual indicator from a first brightness to a second brightness, greater than the first brightness. Additionally or alternatively to one or more of the examples disclosed above, in some examples, the attention of the user includes a gaze of the user, and wherein the method can further include: in accordance with a determination that the gaze of the user is a first distance from the first region, setting the brightness of the first visual indicator to the first brightness; and in accordance with a determination that the gaze of the user is a second distance from the first region, less than the first distance, setting the brightness of the first visual indicator to the second brightness. Additionally or alternatively to one or more of the examples disclosed above, in some examples, the first visual indicator has a color, and the method can further include: in accordance with the determination that the first context is present at the electronic device, and the attention of the user is directed to the first region of the plurality of regions, changing the color of the first visual indicator from a first color to a second color. Additionally or alternatively to one or more of the examples disclosed above, in some examples, the method can further include: in accordance with the determination that the second context is present at the electronic device, and the attention of the user is directed to the first region of the plurality of regions, changing the color of the first visual indicator to a third color, different from the second color.

Some examples of the disclosure are directed to an electronic device, comprising: one or more processors; memory; and one or more programs stored in the memory and configured to be executed by the one or more processors, the one or more programs including instructions for performing any of the above methods.

Some examples of the disclosure are directed to a non-transitory computer readable storage medium storing one or more programs, the one or more programs comprising instructions, which when executed by one or more processors of an electronic device, cause the electronic device to perform any of the above methods.

Some examples of the disclosure are directed to an electronic device, comprising one or more processors, memory, and means for performing any of the above methods.

Some examples of the disclosure are directed to a non-transitory computer readable storage medium storing one or more programs, the one or more programs comprising instructions, which when executed by one or more processors of an electronic device, cause the electronic device to perform any of the above methods.

Some examples of the disclosure are directed to an electronic device, comprising one or more processors, memory, and means for performing any of the above methods.

Some examples of the disclosure are directed to an information processing apparatus for use in an electronic device, the information processing apparatus comprising means for performing any of the above methods.

The foregoing description, for purpose of explanation, has been described with reference to specific examples. However, the illustrative discussions above are not intended to be exhaustive or to limit the disclosure to the precise forms disclosed. Many modifications and variations are possible in view of the above teachings. The examples were chosen and described in order to best explain the principles of the disclosure and its practical applications, to thereby enable others skilled in the art to best use the disclosure and various described examples with various modifications as are suited to the particular use contemplated.

1. A method comprising:
at an electronic device in communication with one or more displays and one or more input devices:
while displaying a first user interface, wherein a first operation is assigned to a first input type, detecting a first input, via a first input device of the one or more input devices, wherein the first input is of a second input type, different from the first input type;
determining an intent based on a current context, wherein the current context includes the first user interface and a direction of gaze of a user of the electronic device; and
in accordance with a determination that the intent for the first input is a request to perform the first operation at the electronic device:
performing the first operation at the electronic device in response to detecting the first input.

2. The method of claim 1, further comprising:
in accordance with a determination that the intent for the first input is not the request to perform the first operation, displaying a second user interface including a first selectable option for performing the first operation and a second selectable option for performing a second operation, different than the first operation.

3. The method of claim 2, further comprising:
detecting a second input directed to the first or second selectable option; and
in response to detecting the second input:
in accordance with a determination that the second input is directed to the first selectable option, performing the first operation at the electronic device; and
in accordance with a determination that the second input is directed to the second selectable option, performing the second operation at the electronic device.

4. The method of claim 1, wherein:
determining the intent includes determining a confidence level associated with the intent; and:
performing the first operation at the electronic device is in accordance with a determination that the confidence level is above a confidence threshold.

5. The method of claim 4, further comprising:
displaying a second user interface including a first selectable option for performing the first operation and a second selectable option for performing a second operation in accordance with a determination that the confidence level does not exceed the confidence threshold.

6-19. (canceled)

20. An electronic device comprising:
one or more processors;
memory; and
one or more programs stored in the memory and configured to be executed by the one or more processors, the one or more programs including instructions for:
while displaying, via one or more displays in communication with the electronic device, a first user interface wherein a first operation is assigned to a first input type, detecting a first input, via a first input device of [the] one or more input devices in communication with the electronic device, wherein the first input is of a second input type, different from the first input type;
determining an intent based on a current context, wherein the current context includes the first user interface and a direction of gaze of a user of the electronic device; and
in accordance with a determination that the intent for the first input is a request to perform the first operation at the electronic device:
performing the first operation at the electronic device in response to detecting the first input.

21. A non-transitory computer readable storage medium storing one or more programs, the one or more programs comprising instructions, which when executed by one or more processors of an electronic device, cause the electronic device to:
while displaying, via one or more displays in communication with the electronic device, a first user interface, wherein a first operation is assigned to a first input type, detect a first input, via a first input device of one or more input devices in communication with the electronic device, wherein the first input is of a second input type, different from the first input type;
determine an intent based on a current context, wherein the current context includes the first user interface and a direction of gaze of a user of the electronic device; and
in accordance with a determination that the intent for the first input is a request to perform the first operation at the electronic device:
perform the first operation at the electronic device in response to detecting the first input.

22-27. (canceled)

28. The electronic device of claim 20, the one or more programs including instructions for:
in accordance with a determination that the intent for the first input is not the request to perform the first operation, displaying a second user interface including a first selectable option for performing the first operation and a second selectable option for performing a second operation, different than the first operation.

29. The electronic device of claim 28, the one or more programs including instructions for:
detecting a second input directed to the first or second selectable option; and
in response to detecting the second input:
in accordance with a determination that the second input is directed to the first selectable option, performing the first operation at the electronic device; and
in accordance with a determination that the second input is directed to the second selectable option, performing the second operation at the electronic device.

30. The electronic device of claim 20, wherein:
determining the intent includes determining a confidence level associated with the intent; and:
performing the first operation at the electronic device is in accordance with a determination that the confidence level is above a confidence threshold.

31. The electronic device of claim 30, the one or more programs including instructions for:
displaying a second user interface including a first selectable option for performing the first operation and a second selectable option for performing a second operation in accordance with a determination that the confidence level does not exceed the confidence threshold.

32. The non-transitory computer readable storage medium of claim 21, the instructions, when executed by the one or more processors, cause the electronic device to:
in accordance with a determination that the intent for the first input is not the request to perform the first operation, display a second user interface including a first selectable option for performing the first operation and a second selectable option for performing a second operation, different than the first operation.

33. The non-transitory computer readable storage medium of claim 32, the instructions, when executed by the one or more processors, cause the electronic device to:
detect a second input directed to the first or second selectable option; and
in response to detecting the second input:
in accordance with a determination that the second input is directed to the first selectable option, perform the first operation at the electronic device; and
in accordance with a determination that the second input is directed to the second selectable option, perform the second operation at the electronic device.

34. The non-transitory computer readable storage medium of claim 21, wherein:
determining the intent includes determining a confidence level associated with the intent; and:
performing the first operation at the electronic device is in accordance with a determination that the confidence level is above a confidence threshold.

35. The non-transitory computer readable storage medium of claim 34, the instructions, when executed by the one or more processors, cause the electronic device to:
display a second user interface including a first selectable option for performing the first operation and a second selectable option for performing a second operation in accordance with a determination that the confidence level does not exceed the confidence threshold.
